(19) United States
(12) Patent Application Publication
(10) Pub. No.: US 2018/0266104 A1
(43) Pub. Date: Sep. 20, 2018

(54) CONTROL SYSTEM AND METHOD FOR MITIGATING THE EFFECTS OF NATURAL HAZARDS

(71) Applicant: The Regents of the University of California, Oakland, CA (US)

(72) Inventors: Paul K. HANSMA, Goleta, CA (US); Henry T. YANG, Santa Barbara, CA (US); Issac Y. KWON, Goleta, CA (US); Connor RANDALL, Goleta, CA (US)

(21) Appl. No.: 15/760,309

(22) PCT Filed: Sep. 15, 2016
(86) PCT No.: PCT/US2016/051929

§ 371 Date: Mar. 15, 2018

Related U.S. Application Data
(60) Provisional application No. 62/219,041, filed on Sep. 15, 2015.

(51) Int. Cl. E04B 1/98; E04H 9/02; F16F 9/20; F16F 9/26

(52) U.S. Cl. CPC E04B 1/985; E04H 9/02; E04H 2009/026; F16F 9/26; F16F 9/20

(57) ABSTRACT

An actuator includes a piston, a relief valve in fluid communication with the piston, and an input shaft for moving fluid in a chamber near the piston. The relief valve determines an amount of force needed to move the piston to compress a fluid. The actuator also includes at least one check valve which allows the input shaft to move back to an equilibrium position with a much lower force than a force needed to compress the fluid. The actuator is a passive device that can be used to prevent motion or isolate a base. The actuator is also incorporated in tuned mass damping systems.

### CROSS-REFERENCE TO RELATED APPLICATIONS

This application claims priority to U.S. Provisional Application No. 62/219,041, filed on Sep. 15, 2015, and entitled “CONTROL SYSTEM AND METHOD FOR MITIGATING THE EFFECTS OF NATURAL HAZARDS,” the disclosure of which is incorporated by reference in its entirety.

### BACKGROUND

There is a need for a device or system of devices to mitigate impacts of natural hazards on civil and mechanical infrastructures in order to prevent natural hazards from becoming disasters. Such hazards include earthquakes, windstorms, tsunamis, landslides and other loads. Resiliency of buildings and other structures include structural and nonstructural systems that, in totality, permit continued occupation or operation in case of an impact by a hazard or multiple hazards

In this century alone, there have been numerous significant earthquakes throughout the world, causing thousands of deaths. The losses from the El Centro, Calif. (1940), Northridge, Calif. (1994), Kobe, Japan (1995), Chi-chi, Taiwan (1999), Gujarat, India (2001), Wenchuan, China (2008), and Tohoku, Japan (2011), earthquakes provide further motivation to study the effects of seismic activity on structures and to develop reliable lifeline engineering technology. Wind forces, though typically less destructive than earthquakes, can also significantly impact the safety and reliability of a structure.

Recent results with models of large architectural structures have documented the effectiveness of systems of sensors and actuators in assessing the condition of Civil Infrastructure System resources as well as significantly reducing potentially damaging structural vibrations caused by simulated earthquakes. These results come from relatively large model structures that can approach the size of real buildings and use conventional sensors and actuators.

There are generally three types of devices and actuators available for structural control applications: passive devices, active devices, and semi-active devices. Passive devices generally require no external energy source to serve their purpose, as opposed to active devices that need external energy to apply forces to a structure. Hybrid devices combine qualities of passive and active devices.

Passive devices include tuned mass dampers, tuned sloshing dampers, viscoelastic dampers, friction dampers, and base isolators, etc. Early studies with passive studied tuned liquid dampers. Other studies were directed toward the response of base-isolation systems. Other efforts involve nonlinear base-isolation, free rolling rods in isolation, and the use of lead-rubber bearings in isolator systems]. Articles also surveyed research in base isolation and also presented case studies of isolator performance during actual earthquakes. Recently, state-of-the-art passive and active structural control systems been reviewed in the literature. They reviewed traditional passive energy dissipation systems which generally operate on principles such as frictional sliding, yielding of metals, phase transformation in metals, deformation of viscoelastic (VE) solids or fluids and fluid orificing. Yet another class of passive device is simple directional mass dampers.

Active mass drivers, active tendons, active variable stiffness systems, aerodynamic appendages, adaptive members, gyroscopic stabilizers, pulse generators, and smart materials such as piezoelectrics are some of the more common active devices. A review paper on civil structural control using piezoceramic smart materials is presented by Song. Active tendon and bracing systems have been studied numerically and examined in laboratory tests. Piezoelectric elements have been used in the shape control of plates, and in control of flutter in aircraft wing boxes.

Semi-active devices, also known as hybrid devices, evolved as alternatives to purely passive or purely active devices for control. Examples of such devices that are commonly studied include active tuned mass dampers and smart base isolators. Magnetorheological dampers for seismic response reduction have been proposed as have other semi-active controller for civil structure. Chen and Chen have designed and tested the semi-active piezoelectric friction dampers on a quarter-scale building model. Recently, the semi-active control devices seem to be the mainstream because of their reliability and efficiency.

### SUMMARY OF THE INVENTION

A full-scale bio-inspired hydraulic passive actuator is disclosed. The full-scale bio-inspired hydraulic passive actuator mitigates natural hazards associated with civil infrastructure by utilizing computational modeling and simulation to integrate theory, computation, experimentation, and data analysis. The full-scale bio-inspired hydraulic passive actuator mimics the sacrificial bonds and hidden length force-displacement behavior that is a molecular mechanistic origin of the toughness of biological composites. The actuator is based on a hydraulic design that can be scaled in order to provide the forces required for full-scale structural control. The full-scale actuator can be used in full-scale structures as well as in retrofitted into current, tuned mass damper systems. This actuator can be used for base-isolation and cross-bracing applications. The actuator will protect civil and mechanical systems, such as buildings, bridges, and other structures. The bio-inspired passive actuator can be implemented in a tuned mass damper system and outperforms the current state of the art passive tuned mass dampers. The actuator can be implemented into various control systems for base-isolation control, and tuned mass damper control. The actuator can also be used for cross-bracings of building frames. The actuators scale up the 200 pN force on the molecules that protect the abalone shells and bone to 100 kN for structural protection: an increase of over 14 orders of magnitude.

The bio-inspired actuators discussed herein will improve the safety, reliability, longevity, and functionality of civil and mechanical infrastructures, such as buildings, bridges, power plant structures, dams, aeroelastic wings, and the like. The structures undergoing the forces associated with earthquakes, hurricane, tsunami, and other disturbances will be more resilient. Structures using this actuator will be better equipped to handle the hazards listed above. Such infrastructures will have multi-hazard resilience and sustainability, and ultimately improve the quality, health, safety, and security of life which these structures support.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1A is a graph of a force displacement curve for abalone shell adhesive associated with an abalone shell.

FIG. 1B is a graph of a force displacement curve for bone associated with an abalone shell.

FIG. 1C is a graph of a force displacement curve for titin associated with an abalone shell.

FIG. 1D is a graph of a force displacement curve for many of the molecules of the abalone shell acting together.

FIG. 2A is an actuator that has a force response curve similar to the natural system, according to an example embodiment.

FIG. 2B is a force displacement curve associated with the hydraulic actuator shown in FIG. 2A, according to an example embodiment.

FIG. 3 is a schematic illustration detailing the hydraulic mechanism of FIG. 2A, according to an example embodiment.

FIG. 4A is a schematic illustration of the actuator or hydraulic mechanism of FIG. 3 at an equilibrium position and includes a force-displacement graph of the hydraulic actuator associated with that position, according to an example embodiment.

FIG. 4B is a schematic illustration of the actuator or hydraulic mechanism of FIG. 3 at position where the piston 330 is being pulled left and includes a force-displacement graph of the hydraulic actuator associated with that position, according to an example embodiment.

FIG. 4C is a schematic illustration of the actuator or hydraulic mechanism of FIG. 3 at position where the piston 330 is returning to the equilibrium position and includes a force-displacement graph of the hydraulic actuator associated with that position, according to an example embodiment.

FIG. 4D is a schematic illustration of the actuator or hydraulic mechanism of FIG. 3 at position where the piston 330 is being forced to the right and includes a force-displacement graph of the hydraulic actuator associated with that position, according to an example embodiment.

FIG. 4E is a schematic illustration of the actuator or hydraulic mechanism of FIG. 3 at position where the piston 320 is returning to the equilibrium position and includes a force-displacement graph of the hydraulic actuator associated with that position, according to an example embodiment.

FIG. 5A is a schematic of a tuned mass damper system 500 that includes an actuator 300, according to an example embodiment.

FIG. 5B is a force-displacement diagram of the tuned mass damping system 500 illustrated in FIG. 5A, according to an example embodiment.

FIG. 6A is a graph showing a Comparison of floor displacement using tuned mass dampers (TMD) with two different damping mechanism: TMD with optimized dashpot (red), TMD with the inventive actuator (black), and its experimental measurement (green), according to an example embodiment.

FIG. 6B is an enlarged view of the graph shown in FIG. 6A.

FIG. 6C is a graphical comparison of the control force output of the various devices discussed in FIG. 6A, according to an example embodiment.

FIG. 7A is a graph of floor displacement amplitude verses frequency of an uncontrolled system, and a system using the inventive actuator, according to an example embodiment.

FIG. 7B is a graph of floor displacement amplitude verses frequency of an optimized conventional viscous damper system, and a tuned mass system using the inventive actuator, according to an example embodiment.

FIG. 8A is a perspective view of an actuator, according to an example embodiment.

FIG. 8B is a partially cut away perspective view of an actuator, according to an example embodiment.

FIG. 9 is a schematic of another embodiment of a tuned mass damper system 900 utilizing a hydraulic actuator 800, according to an example embodiment.

FIG. 10 is a schematic of a mechanical model of a base isolator system that includes an actuator, such as actuator 300, 800 in parallel with a spring and a dashpot, according to another example embodiment.

FIG. 11 is a hydraulic actuator 1100 that can be used either to isolate bases or resist movements, according to another example embodiment.

FIG. 12A is a hydraulic actuator that can be used resist movements in structures, according to another example embodiment.

FIG. 12B is a hydraulic actuator with check valves arranged so that the actuator can isolate bases, according to another example embodiment.

FIG. 13 is a graphical comparison of third story drift under earthquake excitation comparing the uncontrolled case and the controlled case with the cross bracings using the inventive actuator, according to an example embodiment.

FIG. 14 is a graph of theoretical force versus displacement behavior of the bio-inspired hydraulic damper described by the piecewise damping function, according to an example embodiment.

FIG. 15 is a perspective view of a prototype bio-inspired hydraulic damper, according to an example embodiment.

FIG. 16 is a top view showing the prototype bio-inspired hydraulic damper mounted to an electromagnetic linear translation stage, with a load cell mounted between the rod and the base of the electromagnetic stage for monitoring the damper force, according to an example embodiment.

FIG. 17 is a graph of an experimental force versus displacement results for the bio-inspired hydraulic damper compared to the theoretical force versus displacement, according to an example embodiment.

FIG. 18 is a graph of experimental force versus displacement results for the bio-inspired hydraulic damper for two different force settings, high force (800N) and low force (400N), at two loading frequencies of 0.5 Hz and 0.25 Hz, according to an example embodiment.

FIG. 19 is a schematic diagram of a Quarter-car vehicle suspension model, according to an example embodiment.

FIG. 20 is a graph of the input excitation, comprising two road bumps of amplitude 6 cm and 3 cm, according to an example embodiment.

FIG. 21 is a plot of the rider displacement against varying damping coefficients and bio-force, according to an example embodiment.

FIG. 22 is a plot of the rider acceleration against varying damping coefficients and bio-force, according to an example embodiment.

FIG. 23 are various graphs comparing the traditional suspension case versus the bio-inspired damper (−SBHL) case, according to an example embodiment.

FIG. 24 is a schematic of a 76-story structure which will be used to illustrate the effectiveness of the bio-inspired TMD in reducing structural response.

FIG. 25A is a graph comparing peak displacement responses on select floors with five different control cases: i) No Control, ii) Conventional TMD, iii) Semi-Active Variable Stiffness TMD, iv) LQG controlled Active TMD, and v) Bio-inspired TMD.

FIG. 25B is a graph comparing peak acceleration responses on select floors with five different control cases: i) No Control, ii) Conventional TMD, iii) Semi-Active Variable Stiffness TMD, iv) LQG controlled Active TMD, and v) Bio-inspired TMD.

FIG. 25C is a graph comparing RMS displacement responses on select floors with five different control cases: i) No Control, ii) Conventional TMD, iii) Semi-Active Variable Stiffness TMD, iv) LQG controlled Active TMD, and v) Bio-inspired TMD.

FIG. 25D is a graph comparing RMS acceleration responses on select floors with five different control cases: i) No Control, ii) Conventional TMD, iii) Semi-Active Variable Stiffness TMD, iv) LQG controlled Active TMD, and v) Bio-inspired TMD.

FIG. 26A is a graphical comparison of 76^{th} floor displacement between an uncontrolled case and a controlled case using bio-inspired TMD.

FIG. 26B is a graphical comparison of 76^{th} floor acceleration between an uncontrolled case and a controlled case using bio-inspired TMD.

FIG. 27 is a schematic detailing the operation of the bio-inspired damper shown in FIGS. 11, 12A and 12B, according to an example embodiment.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

The description set out herein illustrates the various embodiments of the invention and such description is not intended to be construed as limiting in any manner.

Inspired and challenged by the simplicity and enormous capability of actuators present in bio-organisms, novel control systems and methods have resulted in a fundamental method of designing and optimizing bio-inspired passive actuators for structural control. Force-displacement-velocity plots based on linear quadratic regulator (LQR) control, and a statistic approach based on a linear regression are adopted. This invention opens a new intellectual area of designing and optimizing actuators for protection of civil and mechanical systems such as buildings, bridges, and aircraft.

The actuator of this application is also known as the bio-inspired actuator. This actuator was designed to mimic the force-displacement-velocity relationship of the optimized control obtained from the linear quadratic regulator. The numerical simulation with experimental validation suggested that the bio-inspired passive actuator may be comparable in performance to state-of-the-art semi active actuators. Equipped with high force capacity and compactness, the bio-inspired passive actuator became implementable for a wide spectrum of applications ranging from building small proof-of-concept dynamic systems to vehicle suspension, civil structures including buildings and highway bridges, and even aeronautical vehicles, in a practical manner.

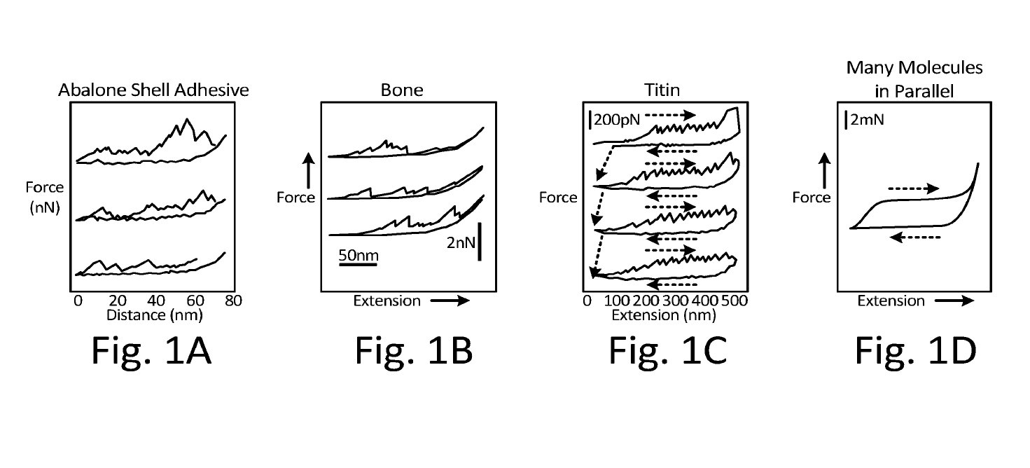

Biological organisms possess the ability to prevent damage caused by natural hazards from becoming disasters. A molecular mechanistic origin for the toughness of natural adhesives, fibers, and composites was described in a Nature paper. The actuator of this invention uses the concept found in an abalone shell in an engineered version of the mechanism. The mechanism includes a sacrificial bond and a hidden length mechanism. FIGS. 1A-1C shows various force displacement curves for various components of the abalone shell. FIG. 1A is a graph of a force displacement curve for abalone shell adhesive associated with an abalone shell. FIG. 1B is a graph of a force displacement curve for bone associated with an abalone shell. FIG. 1C is a graph of a force displacement curve for titin associated with an abalone shell. As can be seen, these various force displacement curves are “choppy” or appear to have a series of portions that feature a spike in an amount of force needed to move the mechanism a short distance. This makes the curves appear to have sawtooth type edges. FIG. 1D is a graph of a force displacement curve for many of the molecules of the abalone shell acting together. In other words in FIG. 1D the various components of the abalone shell are acting in concert or together. The force displacement curve is therefore much smoother. In addition, the force displacement curve has a very low hysteresis. This means that there is a relatively high force needed to move the structure from the equilibrium state and relatively low force for no force to move the structure back to the equilibrium state. When looking at FIGS. 1A, 1B, 1C and 1D, it can be seen that when many molecules or mechanisms act together, it smoothes the sawtooth pattern with a force-displacement curve. The actuator of this invention is engineered to produce a similar force displacement curve that shown in FIG. 1D. The engineered actuator can then be used for structural control.

The key point in abalone shell, sponge spicules, and bone is that the architecture allows most of the energy from threats to be dissipated non-destructively. This concept inspired the actuator. The base idea is to find ways to dissipate energy from threats such as earthquakes and strong winds non-destructively in engineered structures.

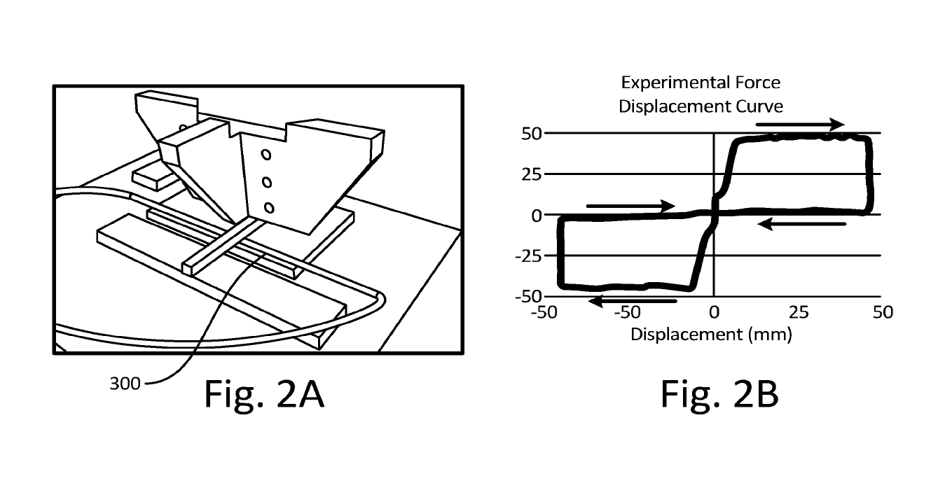

The force-displacement curve for the sacrificial bonds and hidden length mechanism for the abalone shell is very different from the force-displacement curve associated with conventional passive actuators. In this disclosure, a mechanical device that imitates the sacrificial bonds and hidden length mechanism more like the abalone shell was developed. The device allows for energy dissipation as a disruption displaces an object away from equilibrium, but requires little to no energy to return to equilibrium. The device developed is an actuator 300 was that closely replicates the force profile of the sacrificial bonds and hidden length mechanism with many molecules in parallel. The actuator 300 is shown as a small-scale prototype in FIG. 2A. FIG. 2B shows the force displacement curve 200 associated with the actuator 300. As can be seen, the curve produces a relatively high force when moved from the equilibrium position and this forces drops significantly when the actuator returns to the equilibrium position.

The bio-inspired hydraulic actuator 300 which is the subject of this application closely mimics the force-displacement curve of the sacrificial bonds and hidden length mechanism shown in FIG. 1D. FIG. 2B shows the force-displacement curve as experimentally measured for the prototype actuator 300, and the force displacement curve closely matches the biological case with many molecules in parallel shown in FIG. 1D. Notice there is a large force opposing motion from equilibrium while there is a small or substantially non existent force required to return to the actuator to an equilibrium position. This allows a controlled structure to settle to its natural position after an earthquake, or other event and prevents any residual displacements in the structure.

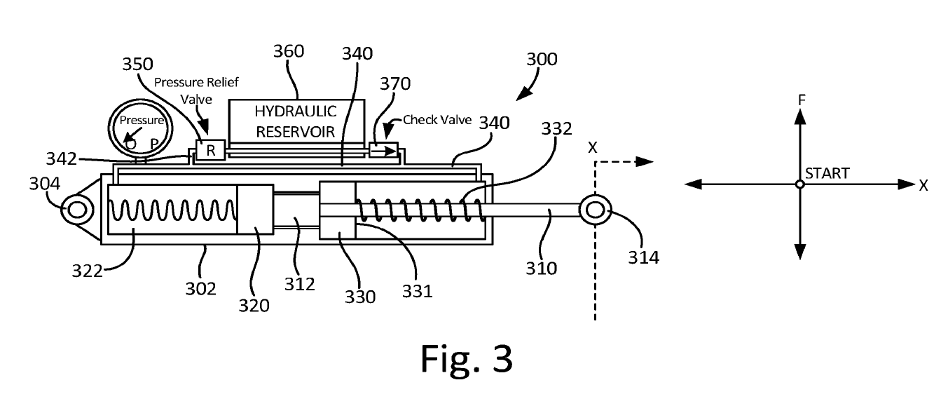

FIG. 3 is a schematic illustration detailing the hydraulic mechanism 300 of FIG. 2A, according to an example embodiment. The hydraulic mechanism or actuator 300 is built as a hydraulic device and can apply the sacrificial bonds and hidden length force profile bi-directionally, allowing for the energy dissipation in two directions away from equilibrium. The hydraulic actuator 300 includes a housing 302. The housing 302 has a first attachment point 304 at one end. The hydraulic actuator 300 also includes an input shaft 310 that has a first end 312 that engages a first hydraulic piston 320 and a second hydraulic piston 330. The input shaft 310 has a second attachment end 314. The second attachment end and the attachment point 314 are located outside the housing 302. The first end 312 is located within the housing 302. When the second attachment end is moved from an equilibrium position, the first end 312 imparts a force on either the first hydraulic piston 320 (input shaft moves left in FIG. 3) or the second hydraulic piston 330 (input shaft moves right and FIG. 3). Each of the hydraulic pistons 320, 330 have substantially the same surface area. The input shaft passes through the second piston 330 through an opening 331 in the second piston 330. The diameter of the second piston is greater than the diameter of the first seven or 320. The diameters are different so as to provide the second piston 330 with a substantially equal surface area to the first piston 320. It should be understood that the surface areas of the first piston 320 and the second piston 330 are substantially the same so that the forces needed to move the input shaft 310 in a positive direction or negative direction are substantially the same. Of course, in some designs it may be preferential or desire to have a force in one direction to be higher than the force of the second direction. In such a design the surface areas of the first piston 320 and the second piston 330 would be different.

A first spring 322 is used to impart a return force on the first piston 320. A second spring 332 is used to impart return force on the second piston 330. In the main housing 302 there is a fluid chamber 324 between the first piston 320 and one end of the housing that includes the first and attachment 304. There is also a fluid chamber 334 located between the second piston 330 and the end that receives the input shaft 310.

The actuator 300 also includes a fluid path 340 the places the first fluid chamber 322 fluid communication with the second fluid chamber 332. The actuator 300 also includes a pressure relief valve 350, hydraulic reservoir 360, and a check valve 370. The pressure relief valve 350, is fluidly connected to the hydraulic reservoir 360 and to the check valve 370. The pressure relief valve 350, the hydraulic reservoir 360 check valve 370 are on a second fluid line 342 is in fluid communication with the first fluid line 340. The check valve 370 makes the fluid line 342 a one-way fluid passage.

Is very well known, hydraulic fluid is substantially uncompressible. Hydraulic fluid is used to fill the chambers 322, 332, and the fluid lines 340, 342 in the hydraulic actuator 300. In operation, when the input shaft 310 is moved to the left, the end 312 imparts or transfers the force to the piston 320 which in turn moves against the hydraulic fluid in the chamber 322. Hydraulic fluid is moved from the chamber 322, past the pressure relief valve 350, and into the hydraulic reservoir 360. The hydraulic fluid sits in the hydraulic reservoir 360 until the force imparted is released or otherwise goes away. The hydraulic fluid in the hydraulic reservoir 360 then passes through the check valve 370 to refill the chamber 322. Similarly, when the input shaft is moved to the right, the end 312 imparts a force on the piston 330 which in turn parts of force onto the fluid within the chamber 332. This again moves fluid into the fluid line 340 and into the fluid line 342. The fluid continues to move past the pressure release valve 350 and into the reservoir 360. When the force is removed, the fluid in the hydraulic reservoir 360 flows past the check valve 370, through the fluid line 340 and into the fluid chamber 332. It should be noted that the actuator 300 is in the equilibrium position as shown in FIG. 3.

As the input shaft 310 is displaced by some external excitation such as earthquake, it will apply a specified force through a unique hydraulic design. The applied force can be regulated by a pressure relief valve 350 that can be adjusted to produce a back pressure at a specified force. A first piston 324 and a second piston 330 within a hydraulic chamber has a set surface area. The surface area on one fluid side of the first piston 320 has a first value and the surface area on the fluid side of the second piston 330 has a second set value. These areas are known and so the force to move the pistons 320, 330 off center is also known. As the shaft returns to equilibrium, a one way valve 370 allows for fluid to flow freely back into the chambers 322, 332 of the actuator 300, requiring little to no force.

The hydraulic actuator 300 has the capability of being tuned rapidly in order to adjust the force exerted. For example, the actuator 300 can be adjusted by turning a knob on the pressure relief valve 350. It is important to note that the actuator 300 is completely passive, and unlike many active and semi-active devices, if the control system fails during an event such as an earthquake, tornado, hurricane, or other load, they will still function properly, making these passive actuators resilient and reliable. Additionally, utilizing the health monitoring system, in a structure that includes a plurality of actuators 300, the plurality of actuators 300 can be tuned quickly in order to adjust for structural changes due to structure modification, load changes, or even damage. This actuator 300 can be implemented for use in a tuned mass damper system as well as other systems such as base isolation and cross bracings of structural frames.

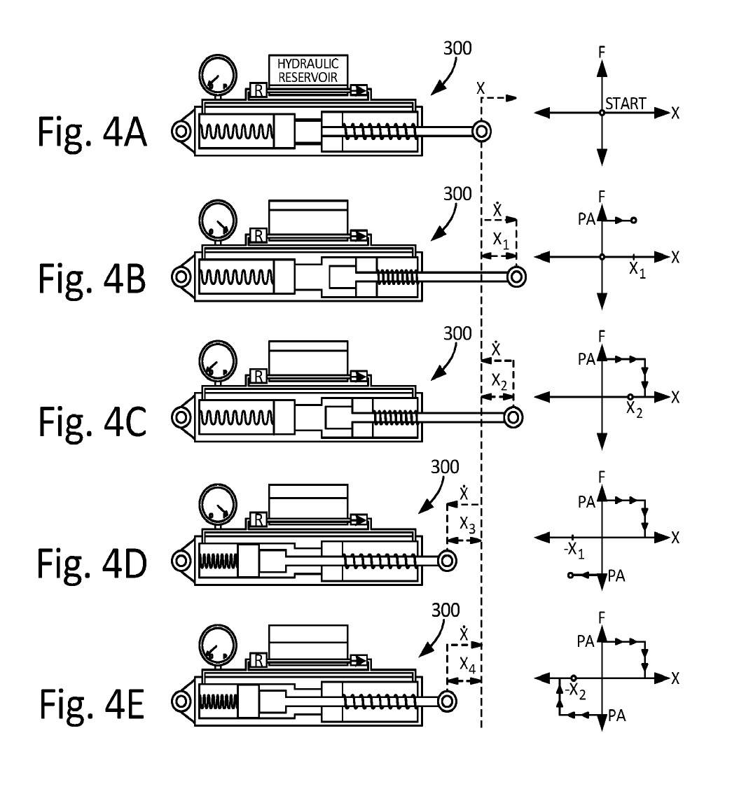

FIGS. 4A-4E illustrate the operation of the actuator 300 sequentially as it is cycled through various positions. In FIG. 4B, the actuator is being pushed outwards from equilibrium (input shaft 310 pulled left) then inwards (input shaft 310 pushed right—FIG. 4D) in order to create the bio-inspired force-displacement relationship. Note that the maximum force is simply the pressure relief valve pressure setting times the piston area. FIG. 4A is a schematic illustration of the actuator or hydraulic mechanism of FIG. 3 at an equilibrium position and includes a force-displacement graph of the hydraulic actuator associated with that position, according to an example embodiment. FIG. 4B is a schematic illustration of the actuator or hydraulic mechanism of FIG. 3 at position where the piston 330 is being pulled right and includes a force-displacement graph of the hydraulic actuator associated with that position, according to an example embodiment. FIG. 4C is a schematic illustration of the actuator or hydraulic mechanism of FIG. 3 at position where the piston 330 is returning to the equilibrium position and includes a force-displacement graph of the hydraulic actuator associated with that position, according to an example embodiment. FIG. 4D is a schematic illustration of the actuator or hydraulic mechanism of FIG. 3 at position where the piston 330 is being forced to the left and includes a force-displacement graph of the hydraulic actuator associated with that position, according to an example embodiment. FIG. 4E is a schematic illustration of the actuator or hydraulic mechanism of FIG. 3 at position where the piston 320 is returning to the equilibrium position and includes a force-displacement graph of the hydraulic actuator associated with that position, according to an example embodiment.

FIGS. 4A-4E details the full operation of the full-scale bio-inspired hydraulic actuator as it is cycled. Furthermore, the force-displacement curve is shown at each stage of actuation. FIG. 4A shows the actuator at equilibrium with no pressure in the system. The equilibrium position is defined as the position where the rod is in the central position of the stroke and both pistons are sitting against the mechanical stop at the center of the cylinder. FIG. 4B illustrates the actuator where the rod has been displaced a distance x₁. As an external force is applied to the rod the pressure within the cylinder will build until it reaches the threshold set by the pressure relief valve. Once this threshold is reached the rod will move and fluid will travel through the pressure relief valve into the low pressure hydraulic reservoir. The external force required to displace the actuator is determined by simply multiplying the pressure threshold set by the pressure relief valve by the cross sectional area of the piston. This position is plotted on the force-displacement curve at a distance of x₁ and a force of PA, where P is the hydraulic pressure of the relief valve, and A is the piston area. FIG. 4C illustrates the actuator 300 as the input shaft or rod 300 is traveling back towards equilibrium on the return stroke. The return spring 332 will push the right piston 330 back towards the center and hydraulic fluid will flow through the check valve 370 from the hydraulic fluid reservoir 360 and fill the right cylinder or chamber. This position is plotted on the force-displacement curve at a distance of x₂ and a force of zero. FIG. 4D illustrates the actuator 330 as the rod or input shaft is traveling to the left away from equilibrium. The rod travels through seals on the right piston 330 and pushes the left piston 320 a distance of x₃. Due to symmetry in the design, this position behaves similar to position shown in FIG. 4B where the force is equal to the pressure relief valve 350 setting times the piston area. Finally, FIG. 4E illustrates the actuator as the rod is traveling towards equilibrium on the return stroke, where no force is applied and the behavior is similar to position shown in FIG. 4C. Cycling the actuator the full stroke gives a force-displacement curve that mimics the sacrificial bonds and hidden length mechanism as described in FIG. 1D.

### Simulation and Experimental Validation of a Tuned Mass Damper System Using an Inventive Actuator

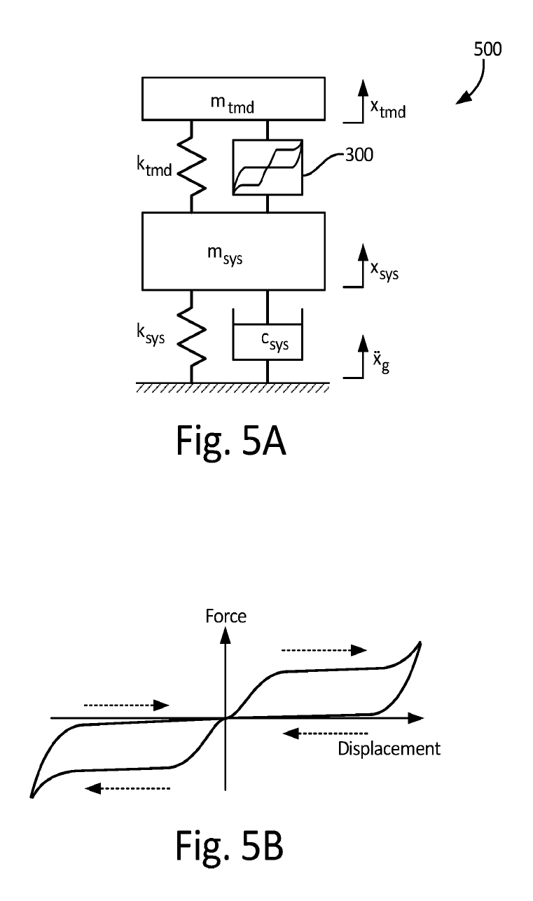

A tuned mass damper is a structural control device which is designed to reduce the structural response under excitation such as earthquake, wind, and the like. A conventional tuned mass damper consists of a single mass, connected to the main structure by a viscous dashpot and a linear spring. A well ‘tuned’ damper can absorb significant energy, thereby reducing the structural response considerably. FIG. 5A is a schematic of tuned mass damper system 500 that includes an actuator 300, according to an example embodiment.

The damping system 500 of sacrificial bonds and hidden length has the force-displacement behavior illustrated in FIG. 5B. The force-displacement curve for the sacrificial bonds and hidden length mechanism is very different from that of conventional passive actuators.

Preliminary numerical testing and experimental verification of the tuned mass damper system 500 with bio-inspired damping using an actuator 300 was performed to evaluate its ability to reduce structural response. For this simulation, a simple single degree of freedom structure model with mass of 46 kg, spring constant of 10350 N/m and damping coefficient of 11 N·s/m was used. A 11 kg tuned mass damper using the bio-inspired hydraulic actuator 300, as shown in FIG. 2A, was installed on top of the test structure for evaluation. An array of numerical simulations were performed to identify the optimal parameters of maximum force output and the stiffness of tuned mass damper using the bio-inspired hydraulic actuator. Hundreds of numerical simulations were performed by incrementally changing the two parameters until the lowest peak floor displacement is achieved. The simulation result showed the optimized maximum force output of 15.7 N and the stiffness of the tuned mass of 1304 N/m. The structure was tested with a frequency varying sine wave input. The natural frequency of the test structure is 2.38 Hz, and the frequency of input sine wave gradually increases from 2.2 Hz to 2.5 Hz in 15 seconds.

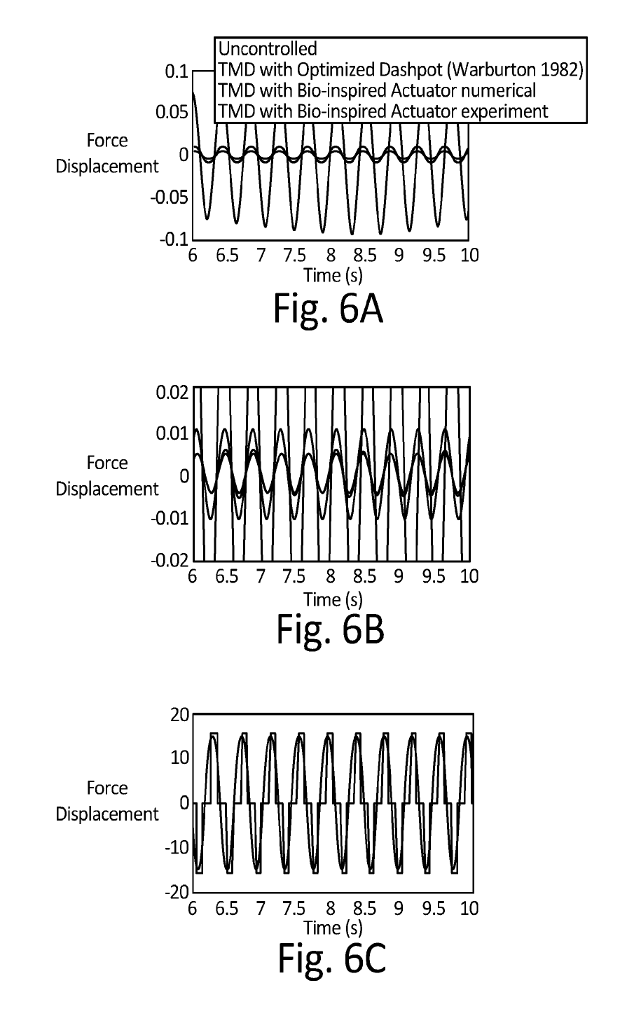

FIGS. 6A-6C show a graphical comparison of floor displacement using tuned mass dampers (TMD) with two different damping mechanism: TMD with optimized dashpot (red), and a TMD with bio-inspired actuator (black), and its experimental measurement (green). FIG. 6C comparison of the control force output, according to an example embodiment.

The comparison of the floor displacement using tuned mass dampers with different damping mechanism shown in FIGS. 4A-4B reveals that while both dampers can significantly reduce structural response as compared to the uncontrolled case, the TMD 500 (shown in FIG. 5A and FIG. 2A) with actuator 300 has superior performance over TMD with optimized dashpot. The experimental measurement of the TMD with bio-inspired damping match closely with its numerical prediction, validating the numerical simulation model. A comparison of output force between the optimized dashpot and the bio-inspired actuator is shown in FIG. 6C. Despite the significant difference in their overall output force profiles, the amplitude of the output force of the two damping mechanisms stay similar to each other.

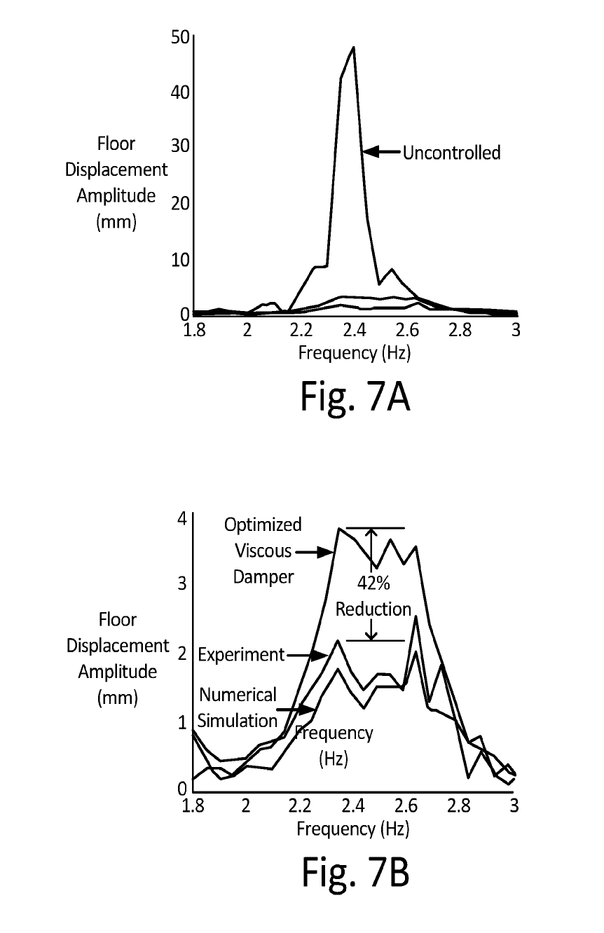

FIG. 7A is a graph of floor displacement amplitude verses frequency of an uncontrolled system, and a system using the inventive actuator, according to an example embodiment. FIG. 7B is a graph of floor displacement amplitude verses frequency of an optimized conventional viscous damper system, and a tuned mass system using the inventive actuator, according to an example embodiment. A Fourier analysis of the floor displacement was performed to compare the effectiveness of protecting the building against the excitation with frequency near the structure's natural frequency. FIGS. 7A and 7B show that TMD system 500 with the bio-inspired damping mechanism, such as actuator 300, reduces the amplitude of floor displacement more efficiently than TMD with optimized dashpot. Note that the peak response using TMD with bio-inspired damping mechanism is 42% less than the one with the optimized dashpot (FIG. 7B).

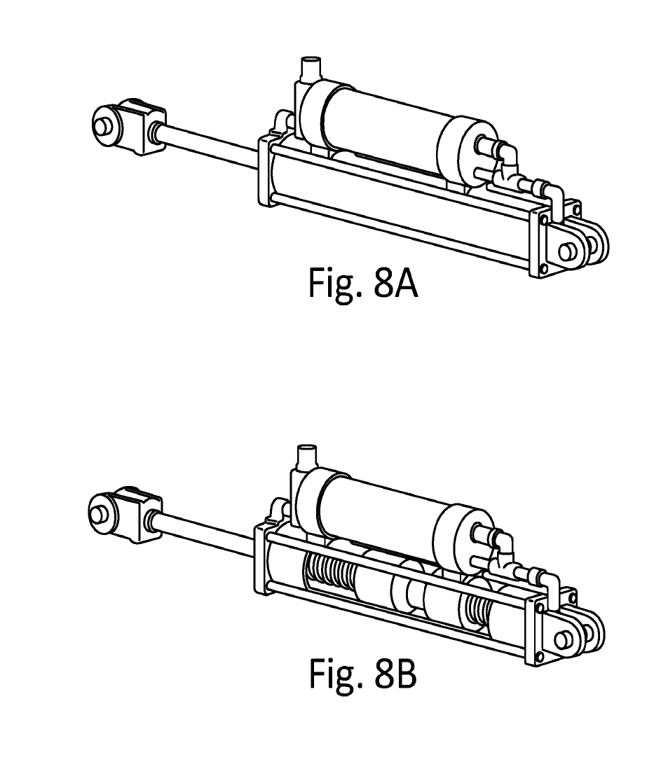

A design for a full-scale hydraulic actuator 800 is shown in FIGS. 8A and 8B, according to an example embodiment. The output forces produced by the actuator 800 provide for full-scale structural control. The hydraulic actuator 800 has a stroke of ±200 mm and a maximum output force of 100 kN. The cylinder has two pistons that are inline in the same barrel for a more compact design. The piston on the left in the cut-out view (FIG. 8B) has seals on the inner diameter to allow for the cylinder rod or input shaft to travel through the piston in order to push the piston to the right. When the cylinder rod travels to the left, it will pull the piston to the left. Due to the cylinder rod traveling through the piston to the left, that piston has a slightly larger diameter in order to have the same cylinder effective area. This ensures that the force of the actuator is the same in both directions of travel. Specific dimensions and specifications for the actuator are provided in Table 1 below. Operation of the actuator 800 was detailed above in the discussion of FIG. 3 and FIGS. 4A-4E.

TABLE 1
Specifications for the hydraulic actuator 800.

| Hydraulic Actuator | | |
|---|---|---|
| Parameter | Value | |
| Maximum Operating Pressure | 20.7 MPa | (3,000 psi) |
| Maximum Force | 100 kN | (22,000 kips) |
| Piston 1 Diameter | 8.1 cm | (3.2 in) |
| Piston 2 Diameter | 7.7 cm | (3.0 in) |
| Rod Diameter | 2.5 cm | (1.0 in) |
| Stroke | ±200 mm | (±7.9 in) |

A large-scale model structure was used to experimentally validate the proposed hydraulic actuator 800. The hydraulic actuator 800 was implemented in a tuned mass damper for the experimental large-scale testing. A three-story steel frame structure was utilized for the large-scale testing. Additional mass is added on each of three floors, making the modal frequencies 1.07 Hz, 3.2 Hz, and 4.7 Hz. The damping ratio of the first mode is identified as 1.3%. The dimensions of the floor are 1.95 m×1.95 m, and the height of each floor is 2.0 m.

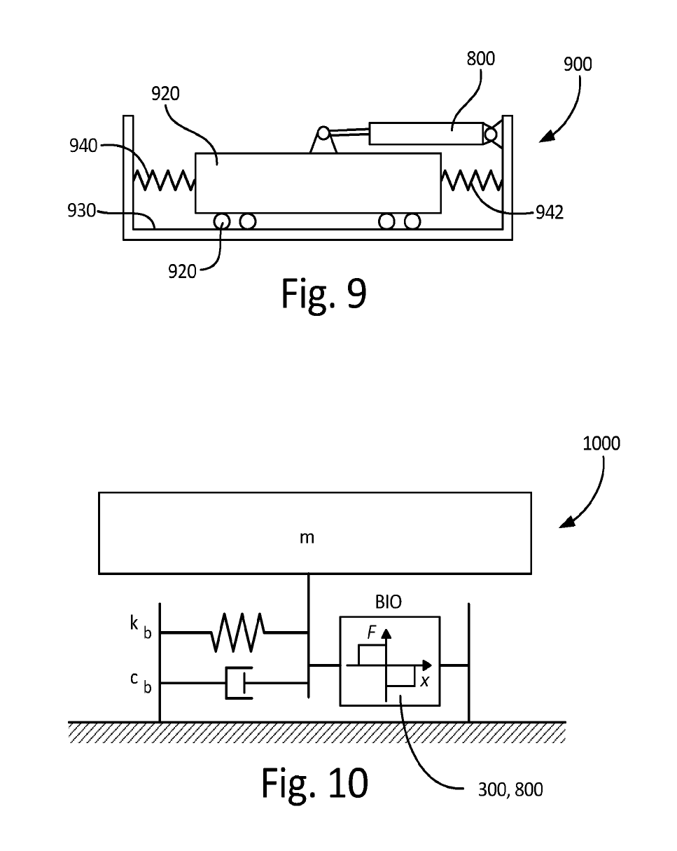

FIG. 9 is a schematic of another embodiment of a tuned mass damper system 900 utilizing a hydraulic actuator 800, according to an example embodiment. A mass 910 is on rollers 920. The mass and rollers fit within a track 930. Springs 940, 942 return the mass to an equilibrium position. The mass is shown in the equilibrium position in FIG. 9. The mass shown in this schematic could be any large structure, such as the one used to test the hydraulic actuator discussed in the previous paragraph.

It is contemplated that the actuator 300, 800 could be used other control systems in addition to tuned mass dampers such as in base isolation systems and cross bracing in order to help mitigate damage from multiple hazards.

Yet another use of the bio-inspired actuator 300, 800 is in a base isolation system 1000. FIG. 10 is a schematic of a mechanical model of a base isolator system 1000 that includes an actuator, such as actuator 300, 800 in parallel with a spring and a dashpot.

FIG. 10 is a schematic of the actuator 300, 800 used as a base isolator 1000, according to an example embodiment. In the base isolation system, m is the isolated mass, BIO is the actuator 300, 800, and k and c denotes stiffness and damping coefficient, respectively. Table 2 below is a comparison of base isolation performances between the isolation system 1000 and semi-active smart isolation system used for the Northridge earthquake in 1994. Note the isolator 1000, called labeled as the “Present Bio-Inspired Passive Base Isolation” appears to outperform in comparison with the semi-active smart isolation slightly in this particular case.

TABLE 2

| | Smart | Present Bio- |
|---|---|---|
| | Isolation[107] | Inspired Passive |
| Parameter | (Semi-active) | Base Isolation |
| Base Drift (mm) | 318.03 | 301.05 |
| Structural Drift (mm) | 7.40 | 5.92 |
| Base Acceleration (mg) | 341.05 | 232.69 |
| Structural Acceleration (mg) | 304.71 | 244.10 |
| Base Shear Force (kN) | 102.81 | 82.38 |

The bio-inspired passive isolator shows comparable performance to the semi-active isolation system under the same earthquake excitation. The performance of the bio-inspired base isolation was compared to those using semi-active isolation utilizing the same isolated structure model. The isolation performance of the bio-inspired base isolation and the semi-active isolation system, under the Northridge earthquake case, is presented in Table 2. The peak values of the response parameters are given. The bio-inspired base isolation appears to outperform in comparison with the semi-active smart isolation slightly in this particular case with the Northridge earthquake.

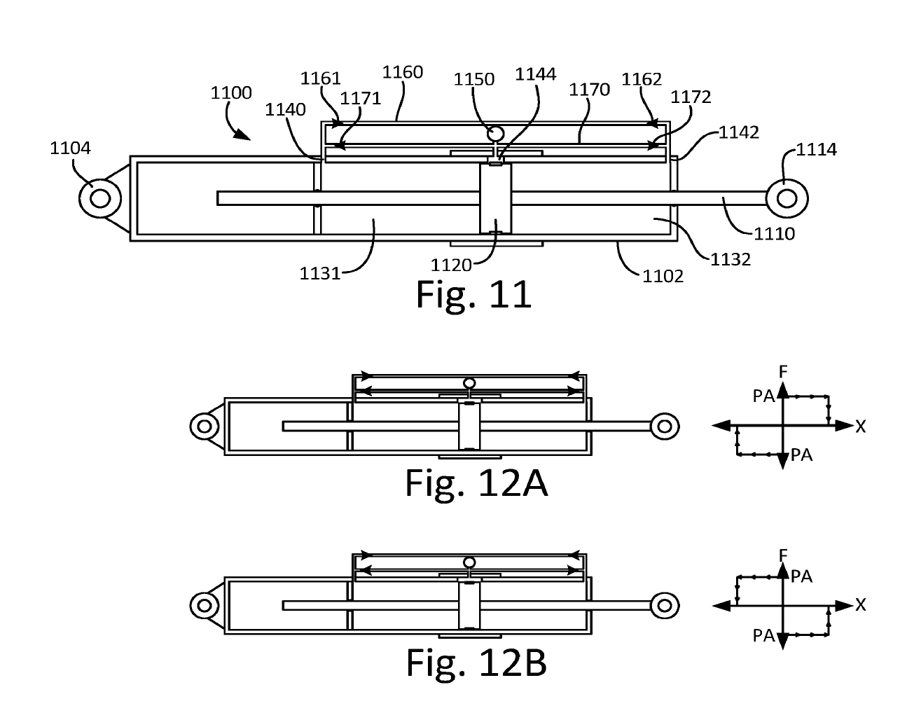

FIG. 11 is a hydraulic actuator 1100 that can be used either to isolate bases or resist movements, according to another example embodiment. The hydraulic actuator 1100 includes a housing 1102 having a first end which terminates in a base mount 1104 and the second end 1106 which receives a input shaft 1110. The input shaft 1110 includes an end with a rod mount 1114. The hydraulic actuator 1100 also includes a piston 1120. The hydraulic actuator 1100 includes a first fluid chamber 1131 on one side of the piston 1120. The hydraulic actuator includes a second fluid chamber 1132 on the other side of the piston 1120. The hydraulic actuator includes a base port 1140, a rod port 1142, and a center port 1144. Each of these ports 1140, 1142, 1144 are in fluid communication with the inside of the housing 1102. More specifically the base port 1140 is in fluid communication with the fluid chamber 1131 and the rod port 1142 is in fluid communication with the fluid chamber 1132. The center port 1144 is in fluid communication with one or the other of these fluid chambers 1131, 1132 depending upon the position of the piston 1120.

As shown in FIG. 11, the actuator is in an equilibrium position. The actuator also includes a pressure relief valve 1150. There is a fluid path 1160 above the pressure relief valve 1150 and another fluid path 1170 which is below the pressure relief valve 1150. In one embodiment, the pressure relief valve is a Precision-Adjustable Pressure Relief Valve available from McMaster-Carr Supply Company of Elmhurst, Ill. as part number 8088K14. There are piston seals at the center port 1144 and on the cylinder opposite the center port 1144. Included in the fluid line or fluid path 1160 is a first check valve 1161 and a second check valve 1162. The fluid path 1170 also includes a third check valve 1171 and a fourth check valve 1172. The actuator 1100 is a double acting hydraulic cylinder with a center port 1144. In one embodiment, the hydraulic actuator includes a Double-Rod Hydraulic Cylinder available from HENNELLS INC located at 1200 WOODWARD HTS, Ferndale, Mich. as part number MS2-NC. The check valves 1161, 1162, 1171, and 1172 all control or limit the flow of fluid to a specific direction. The check valves 1161, 1162, 1171, and 1172 are Quick Opening Check Valves available from McMaster-Carr Supply Company of Elmhurst, Ill. as part number 7777K24.

Table 3 below lists the operating parameters of the actuator shown in FIGS. 11, 12A and 12B that uses the Double-Rod Hydraulic Cylinder available from HENNELLS, INC and the other parts, discussed above, from McMaster-Carr Supply Company of Elmhurst, Ill.

TABLE 3

| Bio-Inspired | | |
|---|---|---|
| Damper Parameter | Value | |
| Pressure Relief Valve Range | 172.4-1275.5 kPa | (25-185 psi) |
| Damping Force Range | 113.6-806.5 N | (24.5-181.3 lbf) |
| Bore Diameter | 3.81 cm | (1.50 in) |
| Rod Diameter | 2.54 cm | (1.00 in) |
| Effective Piston Area (A) | 6.33 cm² | (0.98 in²) |
| Stroke | ±88.90 mm | (±3.50 in) |
| Friction (F_{f}) | 30 N | (6.74 lbf) |
| Air Volume (Vₐ) | 2.5 cm³ | (0.15 in³) |

In operation, an external force is applied through the input shaft 1110. For force is applied in a direction away from equilibrium (any direction moving the piston away from the center of the cylinder) and motion will occur when the force reaches a threshold, set by the pressure relief valve 1150. The force is equal to the pressure relief valve setting multiplied by the cross-sectional area of one side of the piston. The cross-sectional area will not include the portion of the piston that receives the input shaft 1110. When the force is applied, in a direction moving the piston toward equilibrium, fluid will bypass the pressure relief valve thereby requiring little to no forced return to equilibrium. Additionally, other valves can be placed in line with this system in order to introduce damping force to reduce impulse loads. To reduce damping valves having a reduced orifice are placed in the fluid lines. To reduce impulse loads hydraulics number is placed into the input lines.

The actuator 1100 can be used either to isolate bases or resist movements. In other words, the actuator can be set up with sacrificial bonds and hidden length that will resist movements in structures and return back to equilibrium with very little force or the actuator 1100 can be set up with negative sacrificial bonds and hidden length. It is simply a matter of reversing the check valves 1161, 1162, 1171, and 1172. FIGS. 12 A and 12 B shows the different arrangements of the check valves and the force displacement curves associated with these different arrangements. The check valves of FIG. 12B are reversed from the positions of the check valves in FIG. 12A. FIG. 12A is a hydraulic actuator that can be used resist movements in structures, according to another example embodiment. FIG. 12B is a hydraulic actuator with check valves arranged so that the actuator can isolate bases, according to another example embodiment.

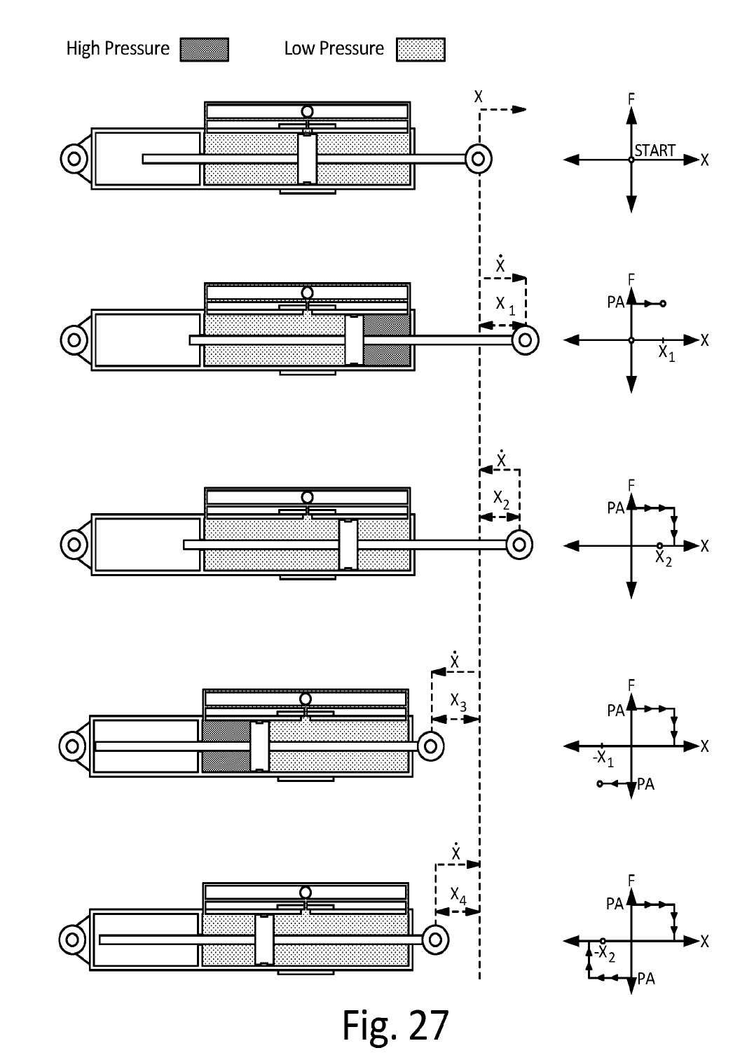

FIG. 27 is a schematic detailing the operation of the bio-inspired damper shown in FIGS. 11, 12A and 12B, according to an example embodiment. The schematic illustrates the operation sequentially as it would be cycled in order to create the bio-inspired force versus displacement relationship used previously with favorable structural control results. The damper schematic of FIG. 27 details the operation of the bio-inspired damper as it is cycled. Furthermore, a basic force versus displacement curve is shown at each stage of actuation, neglecting the initial compliance due to air, for simplicity. Position A shows the damper at equilibrium with no pressure in the system. The equilibrium position is defined as the position where the piston is in the central position of the stroke at the center port. Position B illustrates the damper where the rod has been displaced a distance x₁ to the right. As an external force is applied to the rod the pressure within the cylinder will build until it reaches the threshold set by the pressure relief valve. Once this threshold is reached, the rod will move and fluid will pass through the pressure relief valve and return to the cylinder through the center port. The external force required to displace the damper is determined by simply multiplying the pressure threshold set by the pressure relief valve by the cross sectional area of the piston. This position is plotted on the force versus displacement curve at a distance of x₁ and a force of Pᵣ×A, where Pᵣ is the pressure relief valve setting, and A is the effective piston area. Position C illustrates the damper as the rod is traveling back towards equilibrium on the return stroke. Hydraulic fluid will flow through the check valve from the center port to the rod port. This position is plotted on the force versus displacement curve at a distance of x₂ and a force of zero. Position D illustrates the damper as the rod is traveling to the left away from equilibrium to position x₃. Due to symmetry in the design, this position behaves similar to position B, where the force is equal to the pressure relief valve setting times the piston area. Finally, position E illustrates the damper as the rod is traveling towards equilibrium on the return stroke, where no force is applied and the behavior is similar to position C. Cycling the damper, the full stroke gives a force versus displacement curve that mimics the sacrificial bonds and hidden length mechanism as described in FIG. 2.

It is noted that in some applications, such as base isolation, have more favorable results when the force behaves in the opposite direction. This is called negative sacrificial bonds and hidden length, where the force opposes motion returning to equilibrium but not moving away from equilibrium. For this case, the direction of the check valves would simply be switched to achieve this force output profile.

### Theoretical Damper Behavior

In order to mimic the behavior of the energy dissipating bio-mechanism, a piecewise damping function is described for the theoretical damper operation of Equation 1 (below). As the damper would be disrupted away from equilibrium, a force would need to oppose motion that would rise to a given threshold, where the force would then remain constant until the loading would be reversed. Once the excitation loading is reversed, the damper would allow for travel back to equilibrium without a force. In one embodiment for the hydraulic damper design, the initial loading away from equilibrium, such as shown in FIG. 12A, would need to have a gradual loading to help prevent hydraulic shock and to more closely mimic the bio-mechanism. In order to do this, a small amount of air with a defined volume (Vₐ) is left within the hydraulic system that will provide compliance when transitioning from no damping force to the full damping force. Once the force threshold is met, which would be determined by the pressure relief valve setting and the piston area, the force would then remain constant until the external loading is no longer applied. Due to the seals in the damper there is a constant frictional force when the damper is in motion (F_{f}). This behavior can be described by the following piecewise damping function for dynamic conditions:

$$\begin{matrix}{f}_{BIO} ( x , \dot{x} ) = \{ \begin{matrix}sgn ( x ) [ {P}_{a} A ( \frac{{V}_{a}}{{V}_{a} - A \vert x \vert} - 1 ) + {F}_{f} ] , & x \cdot \dot{x} > 0 and \vert x \vert < {x}_{t} \\ sgn ( x ) [ {P}_{r} A + {F}_{f} ] , & x \cdot \dot{x} > 0 and \vert x \vert \geq {x}_{t} \\ sgn ( \dot{x} ) {F}_{f ,} & x \cdot \dot{x} \leq 0\end{matrix} & ( Eq . 1 )\end{matrix}$$

where Pₐ is the initial pressure, set at atmospheric pressure, of the volume of the air, Vₐ, in the system to add compliance to prevent hydraulic shock and to more closely mimic the bio-mechanism. The effective piston area, A, is the area of the bore minus the area of the rod. The maximum force is set by the pressure relief valve setting, Pᵣ. F_{f} is the frictional force due to the seals and xₜ is defined as the transition distance, which is the distance it takes to compress the air in the cylinder before the maximum force is reached to open the pressure relief valve. The equation is defined as:

$${x}_{t} = \frac{{P}_{r} {V}_{a}}{A ( {P}_{r} + {P}_{a} )} \qquad ( Eq . 2 )$$

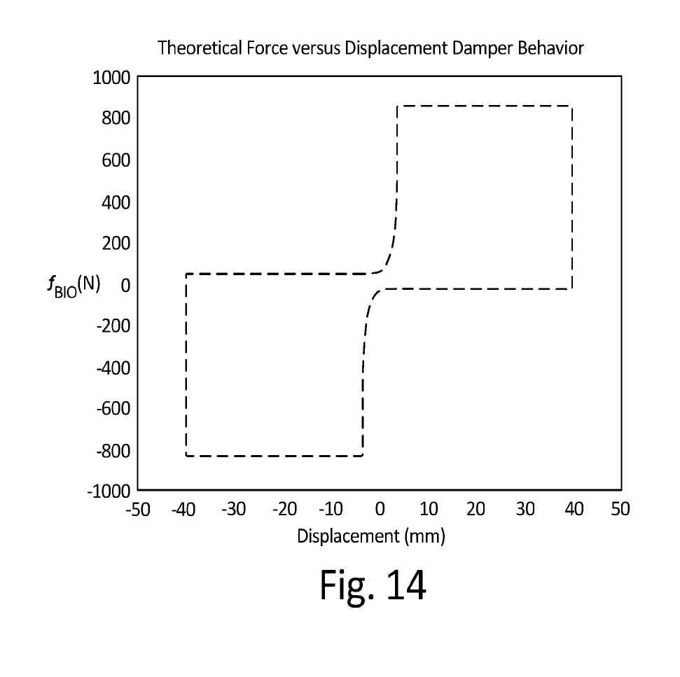

FIG. 14 is a graph of theoretical force versus displacement behavior of the bio-inspired hydraulic damper described by the piecewise damping function, according to an example embodiment. The parameters from the prototype damper listed in Table 3 (above) were input into the piecewise damping function (Eq. 1) to plot ƒ_{BIO} versus displacement, shown in FIG. 14.

### Full-Scale Prototype Damper and Experimental Testing Setup

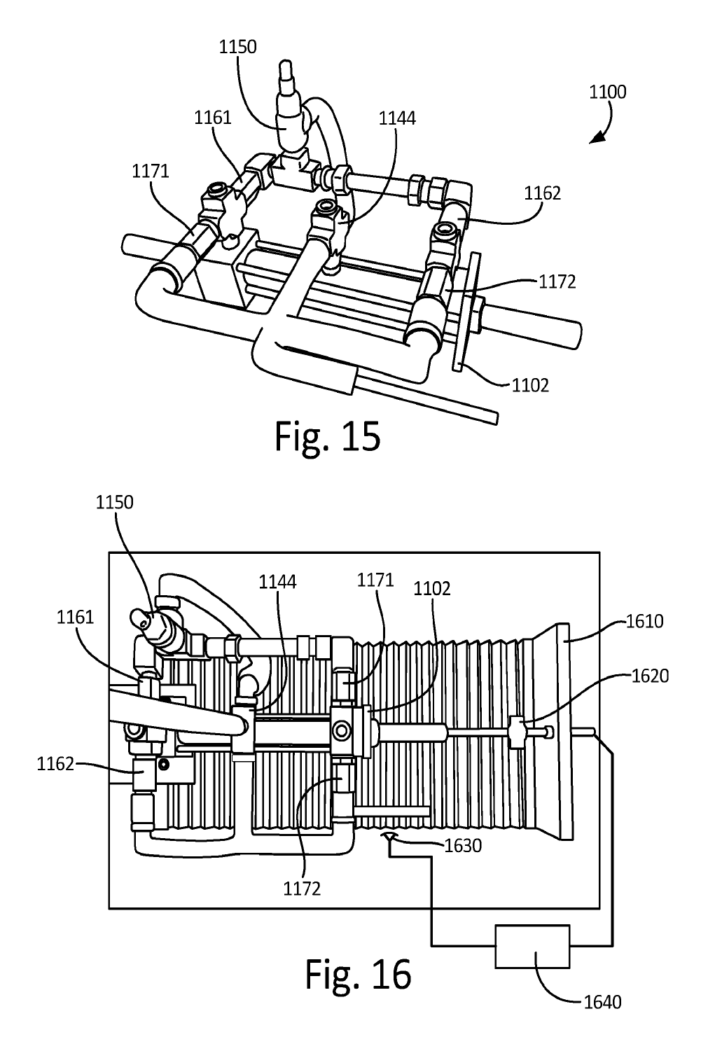

FIG. 15 is a perspective view of a prototype bio-inspired hydraulic damper, according to an example embodiment. The hydraulic damper as fabricated and is shown in FIG. 15. The design uses the components described above with respect to FIGS. 11, 12A and 12B and carries reference numbers for those elements. High-flow chemical resistant tubing, pipe fittings, and tube fittings were used to form the fluid flow paths described with respect to FIGS. 11, 12A and 12B. A ½″ NPT threaded port was machined into the center of the barrel or housing 1102 of the hydraulic cylinder. This threaded center port 1144 provides fluid communication with the hydraulic fluid reservoir. More specifically, the center port is used to attach the hydraulic fluid reservoir to the hydraulic cylinder. The inside of the barrel of the hydraulic cylinder, within the housing 1102, was honed, in order to deburr and polish machined surfaces to prevent wear on the piston seals. Three ports with plugs were added to the fluid flow path to allow for bleeding the system of excessive air. As also discussed above, the output force can be adjusted by changing the pressure relief valve 1150 setting.

FIG. 16 is a top view showing the prototype bio-inspired hydraulic damper 1100 mounted to an electromagnetic linear translation stage 1610, according to an example embodiment. The load stage 1610 includes a base 1612. A load cell 1620 is mounted between the rod of the bio-inspired hydraulic actuator 1100 and the base 1612 of the electromagnetic stage 1610. The load cell 1620 monitors the damper force produced by the hydraulic damper 1100. Cyclic loading on the damper was performed in order to investigate the dynamic damper behavior. A custom mechanical test system was utilized for the mechanical testing. In one embodiment, the load stage 1610 is a linear electromagnetic stage manufactured by H2W Technologies of Santa Clarita, Calif. The load stage is used to drive the damper. The load cell 1620 used in the embodiment shown in FIG. 16, is a 750 lb capacity tension and compression load cell available from Futek of Irvine, Calif. as a Model L2320 load cell. The load cell 1620 is bolted between the rod of the damper and the base of the electromagnetic stage 1610 to record the force behavior of the damper 1100. An amplifier, such as the amplifier module (3G110) also available from Futeck Advanced Sensor Technology, Inc., was used to amplify and condition the signal output from the load cell 1620. A laser displacement sensor 1630 is positioned to record the displacement of the actuator 1100. The laser displacement sensor 1630 used is available from Micro-Epsilon USA of Raleigh, N.C. as a model optoNCDT laser displacement sensor. A LabVIEW data acquisition device 1640 available from National Instruments of Austin, Tex. as a model NI USB 6211, collects data from the load cell 1620 and displacement sensor 1630. The LabVIEW data acquisition device 1640 also outputs an analog signal to drive the electromagnetic stage 1610. A custom program written in LabVIEW records data and outputs the drive signal. Data was recorded with a sampling rate of 250 Hz and digitally filtered with a low-pass filter of 40 Hz to reduce signal noise.

A sinusoidal excitation was used in the study with a frequency of 0.25 Hz and 0.50 Hz in order to investigate the dynamic response of the damper. The total travel of the stage 1610 was 80 mm; therefore, the amplitude of the sinusoidal function was about 40 mm. The force settings used on the actuator included both a high setting (800 N) and a low setting (400 N). The setting between these values can be changed rapidly by simply adjusting the pressure relief valve 1150 setting.

### Full-Scale Prototype Damper Experimental Test Results

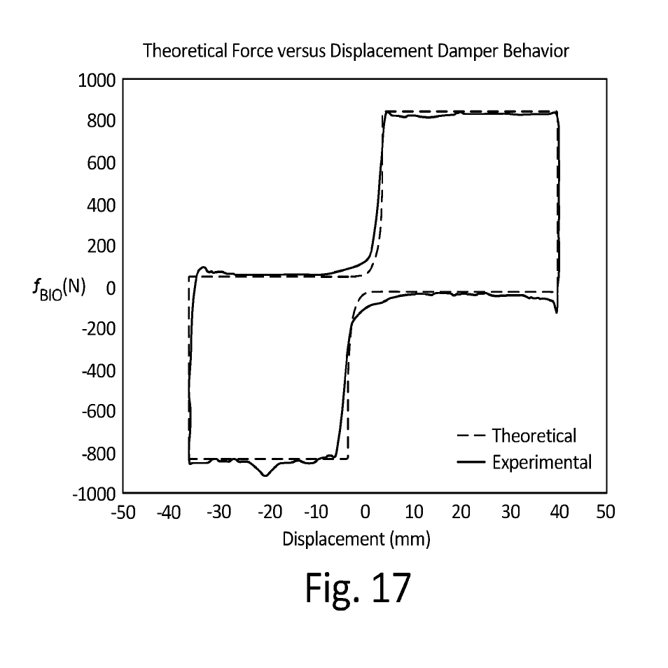

FIG. 17 is a graph of an experimental force versus displacement results for the bio-inspired hydraulic damper compared to the theoretical force versus displacement, according to an example embodiment. The response of the bio-inspired hydraulic damper is shown in a force versus displacement curve in FIG. 17. The case shown in FIG. 17 used a sinusoidal input with an amplitude of 40 mm and a frequency of 0.5 Hz and is compared with the theoretical response of the damper described by the piecewise forcing function in Equation 1. Note the actual experimental displacement was not symmetric due to reaching the limit of the travel in the negative displacement direction on the linear electromagnetic stage. The theoretical displacement was changed to −36.4 mm to match the actual displacement of the linear electromagnetic stage. The experimental response closely matches the theoretical behavior. There is a slight deviation in the loading slope due to compliance in the test system and possibly additional air in the system that was not accounted for. The peak forces are nearly identical and the force remains very constant during cycling.

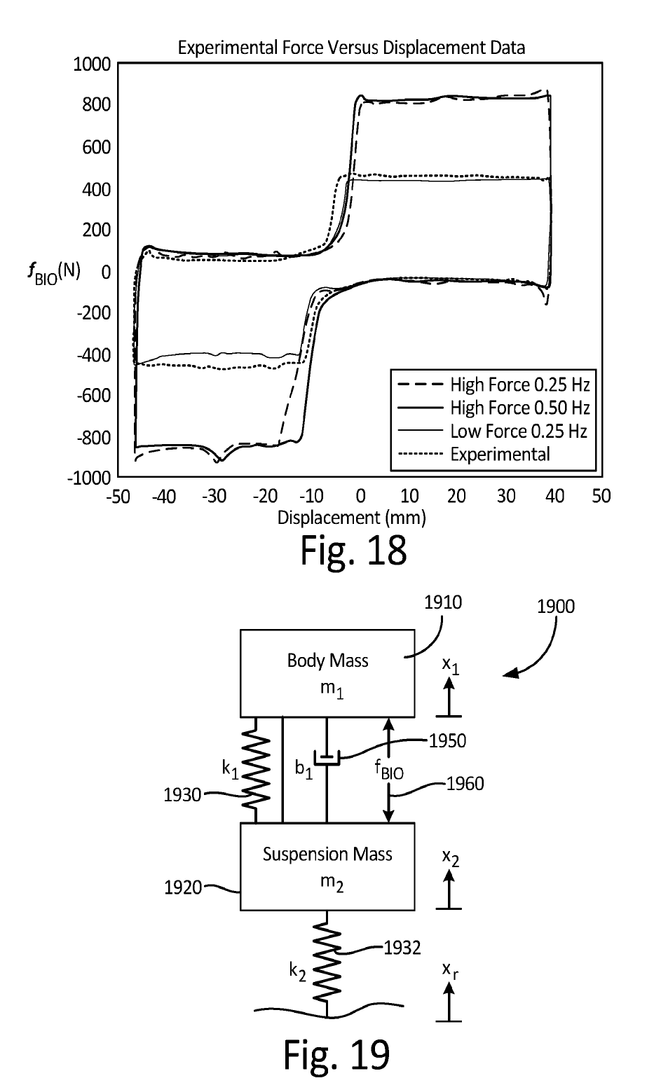

FIG. 18 is a graph of experimental force versus displacement results for the bio-inspired hydraulic damper for two different force settings, high force (800N) and low force (400N), at two loading frequencies of 0.5 Hz and 0.25 Hz, according to an example embodiment. Four tests of the bio-inspired hydraulic damper and are plotted in FIG. 18. To test the adjustability of the damper, two force settings were used at a high setting (800 N) and a low setting (400 N). The experimental peak forces match these values. Tests were also performed at two sinusoidal excitation frequencies of 0.25 Hz and 0.5 Hz with peak to peak amplitude of approximately 80 mm to investigate dynamic effects. The peak forces are nearly identical, showing that a change of a factor of two in the loading rate does not alter the peak damping force; therefore, the velocity dependence on the damping force is minimal for these loading rates.

FIG. 18 shows that the damper behavior closely mimics the behavior of the bio-mechanism that dissipates energy found in nature yet the force is scalable using hydraulics. A description of the theoretical behavior was given with a piecewise forcing function and compared to experimental testing of a prototype actuator with close agreement. Additionally, the damping force is not dependent on velocity for the range tested due to utilizing high-flow components and ports. If damping is desired, a needle valve could be added to the system to tune the damping coefficient. This damper has the potential to be implemented in full-scale structures and could provide improved performance over state-of-the art passive and even semi-active base isolation systems and tuned mass dampers based on previous research studies.

FIG. 19 is a schematic diagram of a Quarter-car vehicle suspension model 1900, according to an example embodiment. The Quarter-car vehicle suspension model 1900 includes a body mass 1910 or the sprung mass m₁, a suspension mass 1920 or the unsprung mass m₂, a suspension component 1930 also deemed k₁, a tire 1932 is represented by k₂, a linear spring 1940 also deemed b₁, a viscous damper 1950, and ƒ_{BIO}, the force from the −SBHL damper 1960. This system will represent the front portion of the bicycle suspension. The quarter-car model suspension system 1900 includes of one fourth of the body mass, suspension components, and one wheel and tire from a car. For this study, a bicycle is investigated, therefore the body mass 1910 would be a fraction of the rider's weight and bicycle frame, while the suspension mass 1920 would be the lower suspension components as well as the wheel and tire.

The performance of the bio-inspired hydraulic damper is now evaluated through numerical simulation. A model of a vehicle suspension system 1900 is considered. The objective of vehicle suspension systems 1900 is to isolate passengers and cargo from vibrations induced by irregularities in the surface of roads while maintaining tire contact to ensure traction. Simple traditional systems use a linear coil spring and a viscous damper with a single damping coefficient. For the case of a bicycle, suspensions utilize similar technology for both the front and rear wheels; however, the damper and spring are typically nonlinear in high-end bicycles. The technology utilized today in high-end mountain bikes is much more sophisticated than a simple linear spring and viscous damper. Typically, an air-spring is utilized due to lower weight and the ease of adjustability; however, downhill bikes still utilize coil springs for longer travel. The damping on high-end mountain bikes also typically has adjustments for the rebound and compression as well as high-speed compression and low-speed compression damping. For the purpose of this study, a linear coil spring and single damping coefficient will be used for simplicity, in order to compare a traditional passive case to a case utilizing a bio-inspired damper.

This study utilizes the novel bio-inspired theoretical damper which exhibits aspects of the mechanism of the negative sacrificial bond-hidden length (−SBHL), where a force opposes motion of the system towards equilibrium, and allows motion freely away from equilibrium. The conversion to −SBHL is achieved by reversing the direction of flow of every check valves and pressure relief valve shown in the above FIGs. A comparison between a traditional passive suspension system and a system with a bio-inspired damper, referred to as the −SBHL damper, is studied. The optimization of the bio-inspired damper is discussed and then the results are compared to the traditional case through a numerical simulation.

FIG. 19 is a schematic diagram of a Quarter-car vehicle suspension model, according to an example embodiment. The quarter-car model has several assumptions. The tire and suspension spring are modeled as a linear spring in this system. There is no rotational motion in the wheel and body, so the focus is on vertical deflections only. The tire is assumed to always be in contact with the road surface. This system can be represented by the following equations of motion:

m₁\ddot{x}₁=k₁(x₂−x₁)+b₁(\dot{x}₂−\dot{x}₁)−ƒ_{BIO} (Eq. 3)

m₂\ddot{x}₂=k₂(xᵣ−x₂)−k₁(x₂−x₁)−b₁(\dot{x}₂−\dot{x}₁)+f_{BIO} (Eq. 4)

where m₁ represents the body mass or the sprung mass and m₂ represents the suspension mass or the unsprung mass. The suspension components consist of k₁, the linear spring, b₁, the viscous damper, and ƒ_{BIO}, the force from the −SBHL damper. The tire is represented by k₂. This system will represent the front portion of the bicycle suspension.
Parameters were obtained from literature to model the bicycle suspension. The total bicycle weight with rider was assumed to be 100 kg, and the front wheel suspension carries 30% to 35% of that weight, so the weight applied to the front suspension was assumed to be 32.5 kg. All the parameters for the traditional suspension case are listed below in Table 4.

TABLE 4
Parameters used for the numerical simulation
for the traditional suspension case.

| Parameter | Value | |
|---|---|---|
| Body Mass, or Sprung Mass (m₁) | 32.5 | kg |
| Suspension Mass, or Unsprung Mass (m₂) | 5.5 | kg |
| Spring Rate (k₁) | 2,950 | N/m |
| Tire Stiffness (k₂) | 35,055 | N/m |
| Damping Coefficient (b₁) | 105 | Ns/m |

The input into the simulation represents two road bumps, one at a height of 6 cm and one at a height of 3 cm. The excitation input can be described by the following equation:

$${x}_{r} ( t ) = a \frac{1 - cos ( 8 π t )}{2} \qquad ( Eq . 5 )$$

where xᵣ is the road disturbance input into the simulation, and a is a piecewise function that represents the height of the bumps for a given time:

$$a = \{ \begin{matrix}6 , & 0.5 \leq t \leq 0.75 \\ 3 , & 3 \leq t \leq 3.25 \\ 0 , & elsewhere\end{matrix} \qquad ( Eq . 6 )$$

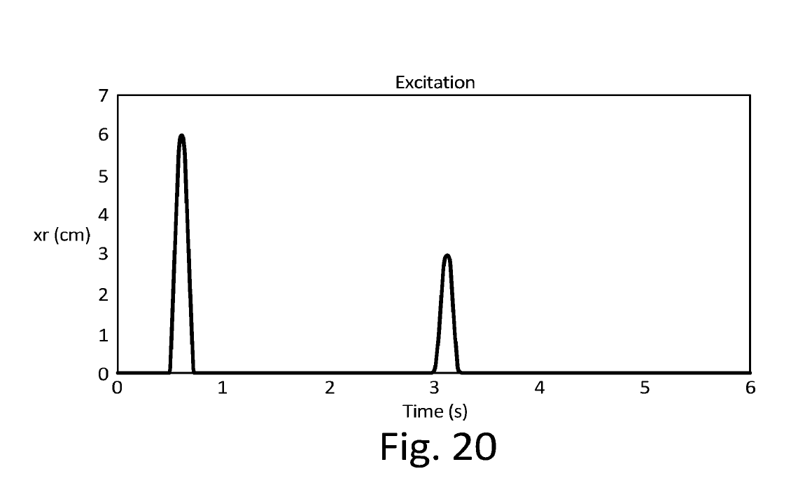

FIG. 20 is a graph of the input excitation, comprising two road bumps of amplitude 6 cm and 3 cm, according to an example embodiment. This excitation is graphed as a function of time and is shown in FIG. 20.

The numerical simulation was performed in Simulink, software developed and made available by MathWorks of Natick, Mass. Simulink is a graphical programming environment for simulating and analyzing dynamic systems.

The −SBHL damper outputs a force that resists motion defined by the following piecewise forcing function:

$$\begin{matrix}{f}_{BIO} ( x , \dot{x} ) = \{ \begin{matrix}- sgn ( x ) {P}_{a} A ( \frac{{V}_{a}}{{V}_{a} - A \vert {x}_{i} - x \vert} - 1 ) , & x \cdot \dot{x} < 0 and \vert x \vert > \vert {x}_{i} \vert - {x}_{t} \\ - sgn ( x ) {F}_{MAX} , & x \cdot \dot{x} < 0 and \vert x \vert \leq {x}_{t} \\ 0 , & elsewhere\end{matrix} & ( Eq . 7 )\end{matrix}$$

where ƒ_{BIO} is the bio-force output of the damper. Pₐ is the initial pressure, set at atmospheric pressure, of the volume of the air, Vₐ, in the damper to add compliance to prevent hydraulic shock and to more closely mimic the biomechanism. The maximum displacement at each cycle is defined as xᵢ. The effective piston area, A, is the area of the bore minus the area of the rod. The maximum force of the damper is F_{MAX}, and xₜ is defined as the transition distance, which is the distance it takes to compress the air in the cylinder before the maximum force is reached. The equation is defined as:

$${x}_{t} = \frac{{P}_{r} {V}_{a}}{A ( {P}_{r} + {P}_{a} )} \qquad ( Eq . 8 )$$

The piecewise forcing function in Equation 7 is slightly more complex than the functions in Equation 2 as it allows for some compliance to transition from the no force condition to the maximum force condition.

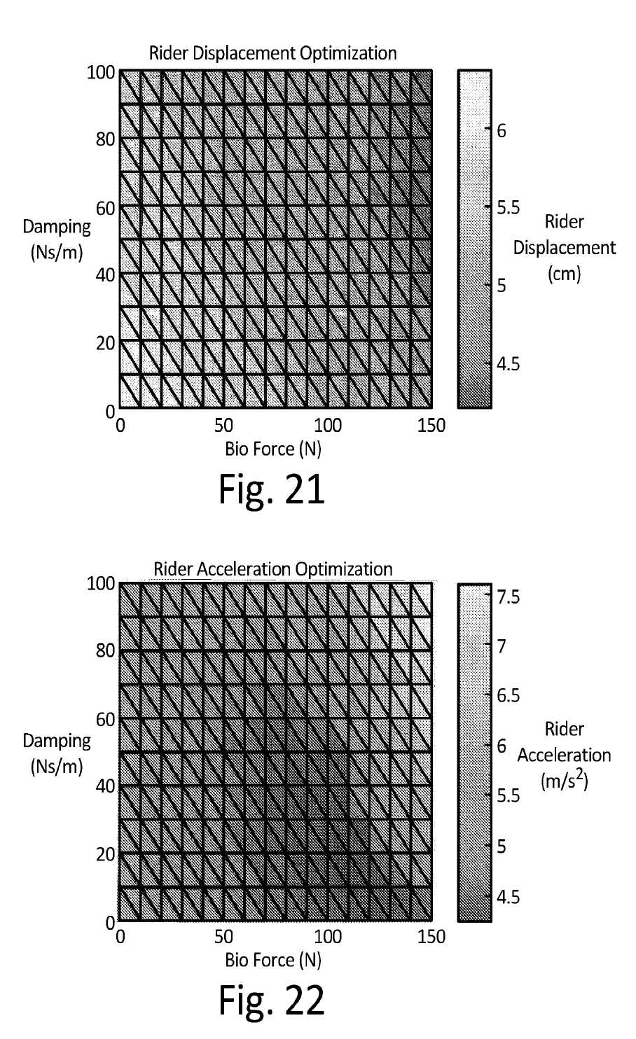

FIG. 21 is a plot of the rider displacement against varying damping coefficients and bio-force, according to an example embodiment. FIG. 22 is a plot of the rider acceleration against varying damping coefficients and bio-force, according to an example embodiment. Both the bio-force and the damping coefficient need to be optimized for the bio-inspired case as they are the two energy dissipating components in the system. The spring coefficients and masses were not changed from the traditional case as the same spring stiffness is required to support the same static load of the body mass, instead the energy dissipating components were optimized.

In order to optimize the damping coefficient and the bio-force, a parametric study was conducted varying both the damping coefficient and the bio-force while simultaneously plotting the results. The objective of this study is to reduce the rider acceleration and rider displacement in order to provide comfort. The rider displacement optimization results are shown in FIG. 21 and the rider acceleration results are shown in FIG. 22.

Optimized values were selected in order to minimize both the rider acceleration and rider displacement. The optimized bio-force used was 115 N and a damping coefficient of 25 Ns/m in order to minimize both rider acceleration and rider displacement. The other parameters were the same as those used in the traditional case. The values used for the −SBHL case are shown in Table 5.

TABLE 5
Parameters used for the numerical simulation
for the bio-inspired damper case (−SBHL).

| Parameter | Value | |
|---|---|---|
| Body Mass, or Sprung Mass (m₁) | 32.5 | kg |
| Suspension Mass, or Unsprung Mass (m₂) | 5.5 | kg |
| Spring Rate (k₁) | 2950 | N/m |
| Tire Stiffness (k₂) | 35055 | N/m |
| Damping Coefficient (b₁) | 25 | Ns/m |
| Bio-Force (F_{MAX}) | 115 | N |
| Air Volume (Vₐ) | 6 | cm³ |
| Effective Damper Piston Area (A) | 6.2 | cm² |

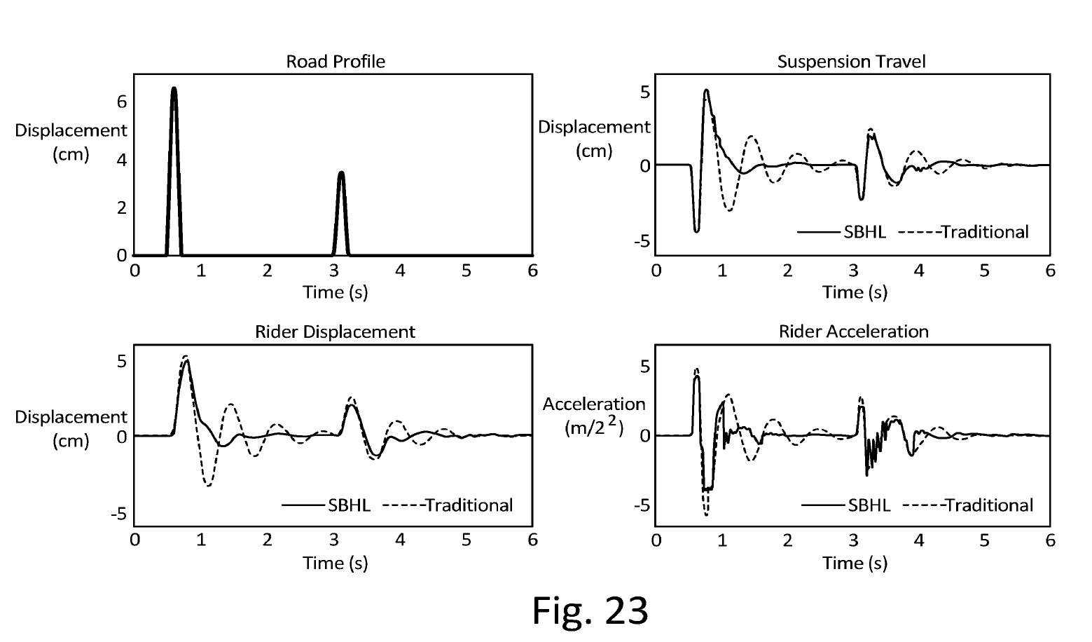

FIG. 23 are various graphs comparing the traditional suspension case versus the bio-inspired damper (−SBHL) case, according to an example embodiment. FIG. 23 includes a road profile which shows the bumps in the road at various times, and includes three other plots comparing the response to the bumps in the road disturbance for the suspension with the −SBHL actuator to the traditional suspension. The three additional plots are for Suspension Travel, Rider Displacement, and Rider Acceleration. The plots are the result after optimizing the suspension. As can be seen, the −SBHL case outperforms the traditional case for the suspension travel, rider displacement, as well as the rider acceleration. It can be seen that the peak amplitudes of each of these parameters is reduced and the disturbance decays rapidly compared to the traditional case.

A table of the absolute peak suspension travel, peak rider displacement, and peak rider acceleration is shown in Table 6. The simulation results show that the addition of the −SBHL damper can reduce peak rider acceleration by nearly 30% while reducing peak suspension travel by 12.5%, and peak rider displacement by 10.9%. The numerical simulation results show the −SBHL damper based on sacrificial bonds and hidden length can outperform current passive bicycle suspensions for this given case, and could potentially be expanded to motorized vehicle suspensions.

TABLE 6
Results comparing the traditional case to the −SBHL
case, showing a significant improvement when utilizing
the −SBHL damper for the peak values of the suspension
travel, rider displacement, as well as rider acceleration.

| | | | % |
|---|---|---|---|
| Parameter | Traditional | −SBHL | Improvement |
| Suspension Travel (cm) | 5.29 | 4.63 | 12.5 |
| Rider Displacement (cm) | 5.45 | 4.85 | 10.9 |
| Rider Acceleration (m/s²) | 5.96 | 4.24 | 28.9 |

The above embodiments validate the effectiveness of the use of the actuator 1100 in applications having a single degree of freedom system with TMD for sinusoidal harmonic excitation, using both numerical and experimental results. Next, the performance of the TMD using an actuator or plurality of actuators in a multiple degree of freedom building subjected to wind excitation is set forth in an example embodiment.

### Wind-Excited Tall Building

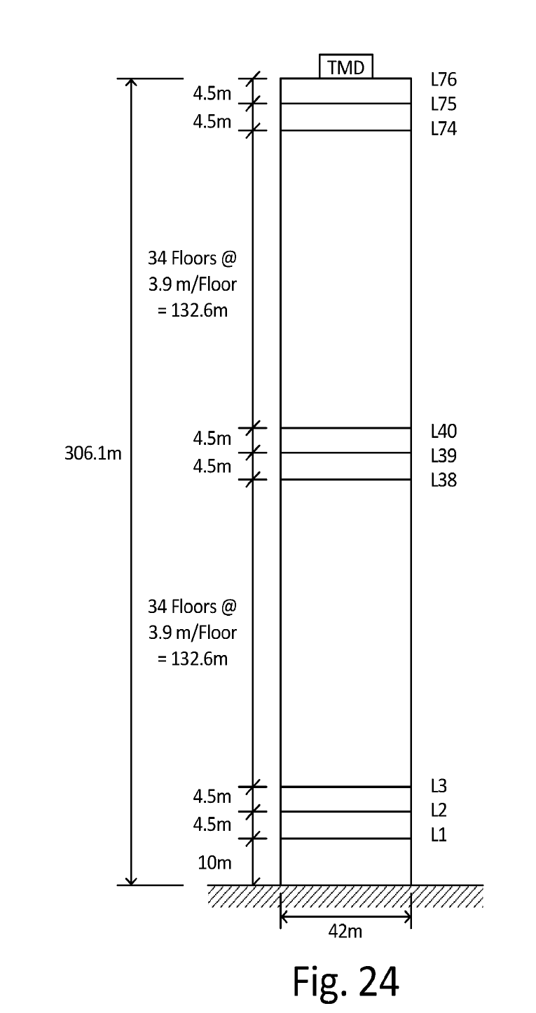

FIG. 24 is a schematic of a 76-story structure which will be used to illustrate the effectiveness of the bio-inspired TMD in reducing structural response. The 76-story building 2400 is a structure which is wind-sensitive. The building 2400 is 306 m high and has a square cross-section of 42 m×42 m. The building is slender with a height to width ratio (aspect ratio) of 7.3, which renders it wind sensitive. A finite element model is constructed with 76 degree of freedom, representing the lateral displacement of each floor. The lowest five natural frequencies are 0.16, 0.765, 1.992, 3.790, and 6.395 Hz. The (76×76) damping matrix for the building with 76 lateral degree of freedom is calculated by assuming 1% damping ratio for the first five modes using Rayleigh's approach.

A TMD with an inertial mass of 500 ton is installed on the top floor, resulting in a 77 degree of freedom system. This is about 45% of the top floor mass, which is 0.327% of the total mass of the building 2400. To save computational effort, the 77 degree of freedom model is reduced to a 24 degree of freedom system such that the first 48 complex modes (eigenvalues and eigenvectors) of the 77 degree of freedom system are retained. The resulting reduced-order state equation is given by Equation 9 where

ż=Az+Bu+EW (Eq. 9)

where x̅=[x′,\dot{x}′]′=48 dimensional reduced-order state vector, and x=[x₃, x₆, x₁₀, x₁₃, x₁₆, x₂₀, x₂₃, x₃₀, x₃₃, x₃₆, x₄₀, x₄₃, x₄₆, x₅₀, x₅₃, x₅₆, x₆₀, x₆₃, x₆₆, x₇₀, x₇₃, x₇₆, xₘ]′=displacement vector with xᵢ being the displacement of the i th floor and xₘ being the relative displacement of the inertial mass of damper with respect to the top floor. Also, A=(48×48) system matrix, B=(48×1) location vector, u=scalar control force, E=(48×77) matrix, and W=(77×1) wind load.

### Multiobjective Optimization Procedure

Twelve nondimensional performance criteria are used for comparisons and evaluations of the control performance. These criteria are given to measure the controller's ability to reduce the floor displacements and accelerations, and the actuator stroke, velocity and power. It is observed that the values of each performance criterion are positive, and the better the performance of the controller, the smaller the values of performance indices J₁, J₂, . . . , J₁₂. An optimal design of the bio-inspired TMD would minimize the performance indices with appropriate values of the three parameters k_{d}, c_{d}, and Fₘₐₓ.

The optimal values of the design parameters k_{d}, c_{d}, and Fₘₐₓ can be found with following procedure.

1. Generate the initial design parameters k_{d}, c_{d}, and Fₘₐₓ.

2. Construct the system matrices and compute the structural response under excitation of the wind load.

3. Compute the performance indices J₁, J₂, . . . , J₁₂.

4. Formulate strategic criterion J (k_{d},c_{d},Fₘₐₓ).

J(k_{d},c_{d},Fₘₐₓ)=J₁(k_{d},c_{d},Fₘₐₓ)×J₂(k_{d},c_{d},Fₘₐₓ)× . . . ×J₁₂(k_{d},c_{d},Fₘₐₓ) (Eq 10)

5. Minimize J (k_{d},c_{d},Fₘₐₓ) with an appropriate optimization algorithm.

Since smaller values of performance indices indicate better performance, a better compromise solution occurs when J (k_{d},c_{d},Fₘₐₓ) is minimized. In this embodiment, the optimized design parameters of k_{d}=517, c_{d}=67.8, and Fₘₐₓ=21.7 that minimize J (k_{d},c_{d},Fₘₐₓ) were derived using the differential evolutionary algorithm (Storn and Prince 1997). Other optimization algorithm, such as the simplex method (Nelder and Mead 1965), can also be used to minimize the strategic criterion J (k_{d},c_{d}, Fₘₐₓ).

### Numerical Simulation Result

A comparison of the displacement and acceleration response with different types of TMD installed on the 76 degree of freedom benchmark building model are presented in FIG. 7 and Tables 1 through 4, assuming 0% uncertainty in stiffness. The structural response data for the uncontrolled case and controlled case with a tuned mass damper (TMD) and an active tuned mass damper (ATMD) controlled by a linear quadratic Gaussian controller. The simulation results for the semi-active variable stiffness-tuned mass damper (SAIVS_TMD) are from Varadarajan and Nagarajaiah (2004).

For clarity, all numerical data are given in Tables 7, 8, 9, 10, set forth below, for peak displacement, peak acceleration, root-mean-square (RMS) displacement and RMS acceleration, respectively, on selected floors of the uncontrolled structure, the structure with conventional TMD, SAIVS_TMD, ATMD, and the bio-inspired TMD.

TABLE 7
Peak Displacement (cm) of the 76-story
Building Using Different Controllers

| | | | | | Current |
|---|---|---|---|---|---|
| Floor | Uncon- | | | | Bio-inspired |
| number | trolled^{a} | TMD^{a} | SAIVS_TMD^{b} | ATMD^{a} | TMD |
| 1 | 0.05 | 0.04 | 0.04 | 0.04 | 0.04 |
| 30 | 6.84 | 5.60 | 5.11 | 5.14 | 4.55 |
| 50 | 16.59 | 13.34 | 12.14 | 12.22 | 10.82 |
| 55 | 19.41 | 15.54 | 14.13 | 14.22 | 12.61 |
| 60 | 22.34 | 17.80 | 16.17 | 16.27 | 14.46 |
| 65 | 25.35 | 20.10 | 18.25 | 18.36 | 16.34 |
| 70 | 28.41 | 22.43 | 20.35 | 20.48 | 18.24 |
| 75 | 31.59 | 24.84 | 22.52 | 22.67 | 20.20 |
| 76 | 32.30 | 25.38 | 23.01 | 23.15 | 20.64 |
| MD | | 42.60 | 68.01 | 74.29 | 80.20 |

^{a}Response of the uncontrolled structure, structure with tuned mass damper and active tuned mass damper based on linear quadratic Gaussian controller are from Yang et al. (2004).
^{b}Response of the structure with semi-active variable stiffness-tuned mass damper is from Varadarajan and Nagarajaiah (2004).

TABLE 8
Peak Acceleration (cm/s²) of the 76-story
Building Using Different Controllers

| | | | | | Current |
|---|---|---|---|---|---|
| Floor | Uncon- | | | | Bio-inspired |
| number | trolled^{a} | TMD^{a} | SAIVS_TMD^{b} | ATMD^{a} | TMD |
| 1 | 0.05 | 0.04 | 0.04 | 0.04 | 0.04 |
| 30 | 6.84 | 5.60 | 5.11 | 5.14 | 4.55 |
| 50 | 16.59 | 13.34 | 12.14 | 12.22 | 10.82 |
| 55 | 19.41 | 15.54 | 14.13 | 14.22 | 12.61 |
| 60 | 22.34 | 17.80 | 16.17 | 16.27 | 14.46 |
| 65 | 25.35 | 20.10 | 18.25 | 18.36 | 16.34 |
| 70 | 28.41 | 22.43 | 20.35 | 20.48 | 18.24 |
| 75 | 31.59 | 24.84 | 22.52 | 22.67 | 20.20 |
| 76 | 32.30 | 25.38 | 23.01 | 23.15 | 20.64 |
| MD | | 42.60 | 68.01 | 74.29 | 80.20 |

^{a}Response of the uncontrolled structure, structure with tuned mass damper and active tuned mass damper based on linear quadratic Gaussian controller are from Yang et al. (2004).
^{b}Response of the structure with semi-active variable stiffness-tuned mass damper is from Varadarajan and Nagarajaiah (2004).

TABLE 9
RMS Displacement (cm) of the 76-story
Building Using Different Controllers

| | | | | | Current |
|---|---|---|---|---|---|
| Floor | Uncon- | | | | Bio-inspired |
| number | trolled^{a} | TMD^{a} | SAIVS_TMD^{b} | ATMD^{a} | TMD |
| 1 | 0.017 | 0.012 | 0.01 | 0.010 | 0.010 |
| 30 | 2.154 | 1.476 | 1.29 | 1.261 | 1.261 |
| 50 | 5.219 | 3.567 | 3.10 | 3.040 | 3.037 |
| 55 | 6.106 | 4.170 | 3.63 | 3.552 | 3.548 |
| 60 | 7.023 | 4.792 | 4.16 | 4.079 | 4.074 |
| 65 | 7.966 | 5.431 | 4.72 | 4.620 | 4.614 |
| 70 | 8.923 | 6.079 | 5.28 | 5.168 | 5.161 |
| 75 | 9.915 | 6.751 | 5.86 | 5.736 | 5.727 |
| 76 | 10.137 | 6.901 | 5.99 | 5.863 | 5.854 |
| MD | | 12.757 | 22.37 | 23.026 | 28.820 |

^{a}Response of the uncontrolled structure, structure with tuned mass damper and active tuned mass damper based on linear quadratic Gaussian controller are from Yang et al. (2004).
^{b}Response of the structure with semi-active variable stiffness-tuned mass damper is from Varadarajan and Nagarajaiah (2004).

TABLE 10
RMS Acceleration (cm/s²) of the 76-story
Building Using Different Controllers

| | | | | | Current |
|---|---|---|---|---|---|
| Floor | Uncon- | | | | Bio-inspired |
| number | trolled^{a} | TMD^{a} | SAIVS_TMD^{b} | ATMD^{a} | TMD |
| 1 | 0.06 | 0.06 | 0.06 | 0.06 | 0.28 |
| 30 | 2.02 | 1.23 | 0.99 | 0.89 | 1.04 |
| 50 | 4.78 | 2.80 | 2.17 | 2.03 | 2.13 |
| 55 | 5.59 | 3.26 | 2.52 | 2.41 | 2.49 |
| 60 | 6.42 | 3.72 | 2.88 | 2.81 | 2.82 |
| 65 | 7.31 | 4.25 | 3.30 | 3.16 | 3.24 |
| 70 | 8.18 | 4.76 | 3.69 | 3.38 | 3.58 |
| 75 | 9.14 | 5.38 | 4.19 | 3.34 | 4.02 |
| 76 | 9.35 | 5.48 | 4.28 | 4.70 | 4.30 |
| MD | | 13.86 | 22.81 | 22.40 | 28.13 |

^{a}Response of the uncontrolled structure, structure with tuned mass damper and active tuned mass damper based on linear quadratic Gaussian controller are from Yang et al. (2004).
^{b}Response of the structure with semi-active variable stiffness-tuned mass damper is from Varadarajan and Nagarajaiah (2004).

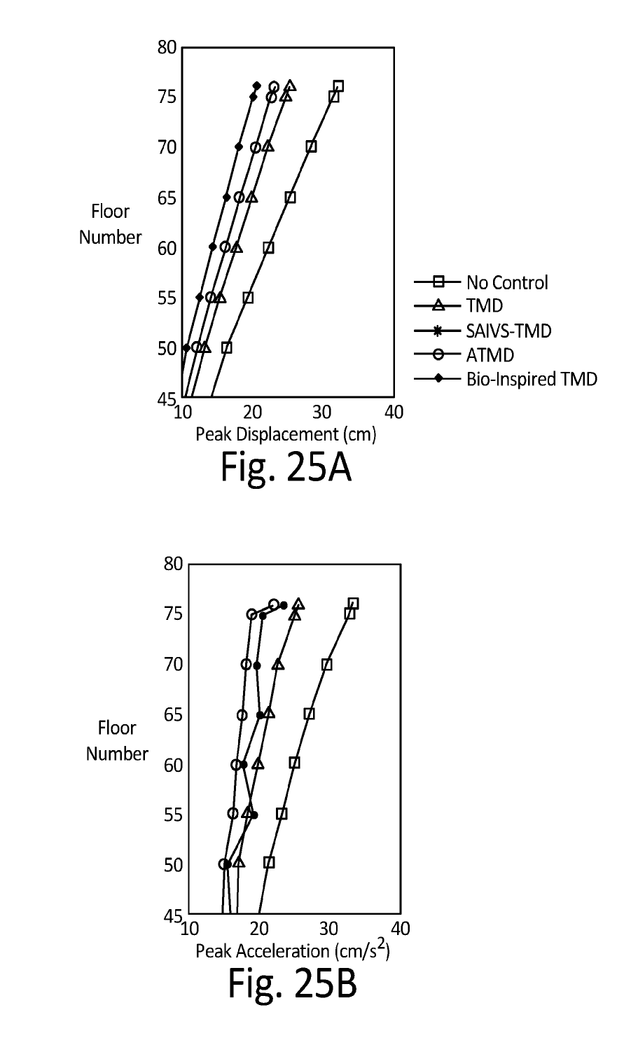

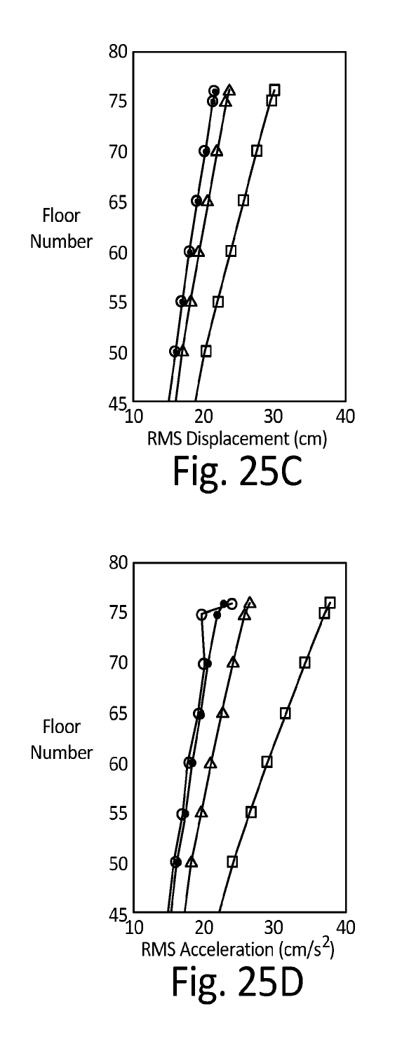

FIGS. 25A, 25B, 25C, and 25D are comparisons of peak displacement (FIG. 25A), peak acceleration (FIG. 25B), RMS displacement (FIG. 25C), RMS acceleration (FIG. 25D) responses on select floors with five different control cases: i) No Control, ii) Conventional TMD, iii) Semi-Active Variable Stiffness TMD, iv) LQG controlled Active TMD, and v) Bio-inspired TMD. To better illustrate the comparison, FIG. 25A shows the plot of the peak displacement of the selected floors. The result shows that the bio-inspired TMD reduces the peak displacement of the 76th floor by 36% when compared to the uncontrolled case.

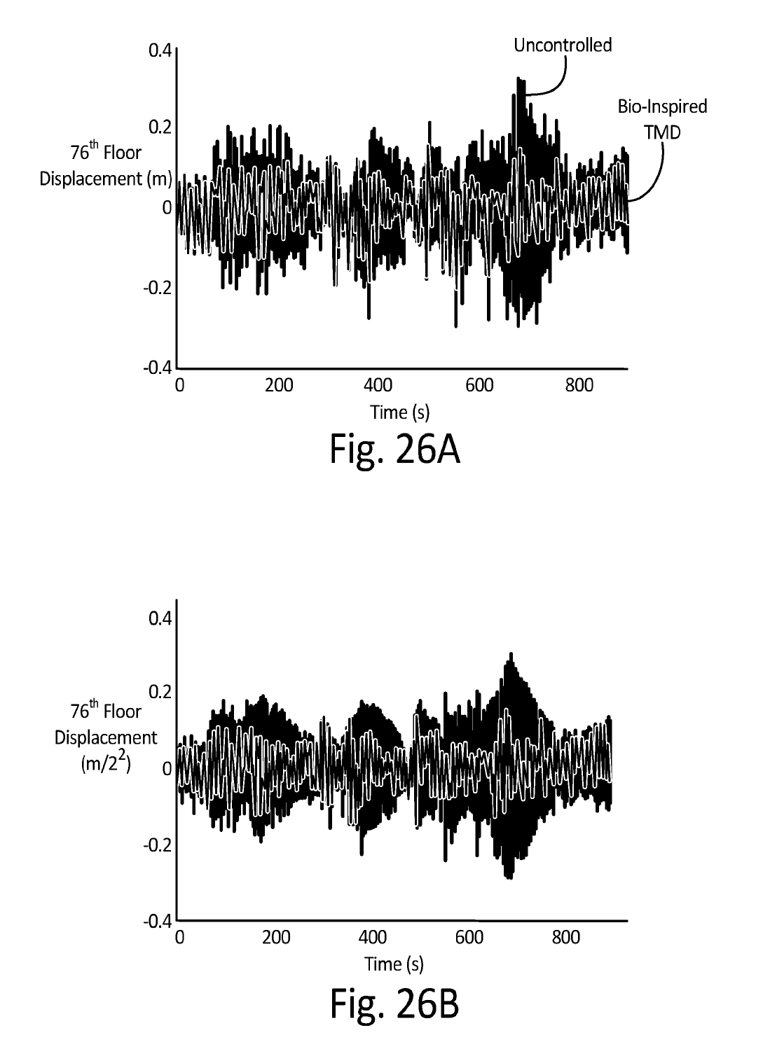

FIG. 26A is a graphical comparison of 76^{th} floor displacement between an uncontrolled case and a controlled case using bio-inspired TMD. FIG. 26B is a graphical comparison of 76^{th} floor acceleration between an uncontrolled case and a controlled case using bio-inspired TMD. Now looking at FIGS. 25A, 25B, 25C, and 25D and FIGS. 26A and 26B, various aspects of the comparisons will be discussed.

The time history of the 76th floor displacement over 900 seconds is plotted in FIG. 26A. The reduction of peak displacement in the case of SAIVS_TMD and ATMD are 32% and 28%, respectively. It should be noted that the peak values listed in Tables 7 and 8 using different control systems are not necessarily found in the same time line. For example, FIG. 26A shows that the peak displacement of the uncontrolled structure occurs at t=690 second, while the peak displacement of the structure with the bio-inspired TMD occurs at t=504 second.

FIG. 25B shows the plot of the peak acceleration on the select floors to better illustrate the comparison. The comparison shows that the bio-inspired TMD reduces the peak acceleration of the 76th floor by 42% when compared to the uncontrolled case. The time history of the 76th floor acceleration over 900 seconds is plotted in FIG. 26B. The corresponding reduction in the case of SAIVS_TMD and ATMD are 53 and 49%, respectively.

FIGS. 25C and 25D show the plots of the RMS displacement and acceleration on the selected floors to better illustrate the comparison. The reductions in the 76th floor displacement and acceleration RMS responses using the bio-inspired TMD are 42 and 54%, respectively, when compared to the uncontrolled case. Similar reductions are observed in the cases of SAIVS_TMD and ATMD. Throughout the comparisons, the bio-inspired TMD constantly shows significantly better response reduction performance compared to the passive TMD. As shown in FIG. 25C and FIG. 25D, the graphs representing the RMS values of the bio-inspired TMD, SAIVS_TMD, and ATMD are close to each other, and the difference is almost indistinguishable in some areas. It is important to note that the present bio-inspired TMD is a passive device, and it not only surpasses the performance of its passive peer devices, but also is comparatively effective as the state-of-the-art semi-active and active devices.

A tuned mass damper using the novel bio-inspired hydraulic actuator (bio-inspired TMD) was developed, built, tested and experimentally validated for structural vibration reduction against a harmonic excitation simulating vortex shedding of wind on a damped single degree of freedom system. The experimental measurement using the small scale prototype bio-inspired TMD showed close match to the numerical simulations result, validating the numerical model of the theoretical system. For the illustrative example, the result obtained with the bio-inspired TMD also showed a significant improvement in the main mass displacement reduction compared to the one with optimized viscous damper over the entire range of excitation frequency used for the simulation.

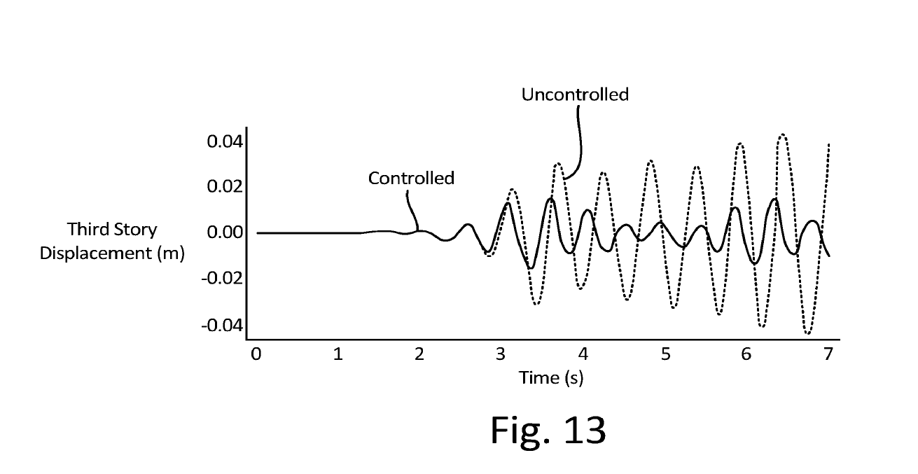

Additionally it should be noted that optimizing cross bracing for structures could be a promising strategy to control structural response. It is contemplated that the full-scale actuator can be incorporated into structural cross-bracing, to optimize its performance in connection with cross bracing for structural control. FIG. 13 is a graphical comparison of third story drift under earthquake excitation comparing the uncontrolled case and the controlled case with the cross bracings using the inventive actuator, according to an example embodiment. A preliminary numerical simulation using the bio-inspired actuator as cross bracing shows a significant improvement of reducing structural response compared to an uncontrolled case. The simulation used the numerical model based on the experimental structure under 1940 El Centro earthquake excitation. The control force was applied to the first floor only as two diagonal cross braces.

Implementing the bio-inspired hydraulic actuator into these other control systems could provide structural control for multiple hazards. For example, a base isolation system can be developed to prevent damage from an earthquake while a tuned mass damper could be developed on the same structure to protect the structure from high winds. This multi-control system approach could prevent disasters from a broad range of natural hazards.

An actuator includes a housing, a first chamber, a second chamber, a first piston and a second piston. The first chamber is positioned within the housing near a first end of the housing. The second chamber is positioned within the housing near a second end of the housing. The first piston has a first piston area. The first piston compresses or pressurizes fluid within the first chamber when moved in a first direction. The second piston has a second piston area. The second piston compresses or pressurizes fluid within the second chamber when moved in a second direction. A pressure relief valve is in fluid communication with the first chamber and the second chamber. An input shaft moves the first piston in the first direction and the second piston in the second direction. The compressed or pressurized fluid flows through the pressure relief valve to a fluid reservoir when one of the first piston is compressing fluid in the first chamber or the second piston is compressing fluid in the second chamber. A check valve at the output of the reservoir that opens when the pressure on the fluid in one of the first chamber or the second chamber is released. The pressure relief valve determines an amount of force needed to move the piston. The pressure relief valve is adjustable. The the input shaft has an equilibrium position between a first position where the first piston is exerting a force on the fluid in the first chamber and a second position where the second piston is exerting a force on the fluid in the second chamber. The force needed to move fluid from the first chamber is equal to the area of the first piston in contact with fluid in the first chamber multiplied by the reading of the pressure produced by the pressure relief valve. The force needed to move fluid from the second chamber is equal to the area of the second piston in contact with fluid in the second chamber multiplied by the reading of the pressure produced by the pressure relief valve. The actuator wherein the force needed to return the input shaft to a position near the equilibrium position is in the range of 0.6 of the force needed to move fluid to 0.2 of the force. In some embodiments the range is 0.5 to substantially 0.1 of the force. In some embodiments the range is 0.4 to substantially 0.09 of the force. In some embodiments the range is 0.3 to substantially 0.08 of the force. In some embodiments the range is 0.2 to substantially 0.06 of the force. In some embodiments the range is 0.15 to substantially 0.05 of the force. In some embodiments the range is 0.5 to substantially zero. Suffice it to say that the return force is substantially less than the force needed to move the piston from the equilibrium position. The check valve opens to allow fluid in the fluid reservoir to flow back to one of the first chamber or the second chamber when the input shaft is moved from one of the first position or the second position toward the equilibrium position. The actuator also includes a first return spring attached to the first piston to return the first piston to the equilibrium position, and a second return spring attached to the second piston to return the first piston to the equilibrium position.

A hydraulic actuator includes a housing having a center port. The housing has a bore therein and a piston positioned within the bore of the housing. The center port communicates with the bore. The piston is movable within the bore from an equilibrium position where the piston covers or substantially seals the center port. The piston also forms a first chamber in the bore on one side of the piston and a second chamber in the bore on the other side of the piston. The first chamber is positioned within the housing near a first end of the housing. The second chamber positioned within the housing near a second end of the housing. The piston has a first piston area facing the first chamber and has a second piston area facing the second chamber. A pressure relief valve is in fluid communication with the first chamber and the second chamber. The actuator also includes a first fluid path in fluid communication with the first chamber, the second chamber and the pressure relief valve. The actuator also includes a second fluid path in fluid communication with the first chamber, the second chamber and the pressure relief valve. An input shaft for moving the piston in the first direction toward the first chamber, the fluid flowing through the pressure relief valve when the piston is compressing fluid in the first chamber, the input shaft for moving the piston in a secc direction toward the second chamber and through the pressure relief valve when the piston is compressing fluid in the second chamber. The hydraulic actuator also includes a first check valve, and a second check valve. One of the first and second check valves prevents flow in a direction and the other of the first and second check valves allows flow as the piston is moved toward the equilibrium position. The hydraulic actuator also includes a third check valve, and a fourth check valve. One of the third and fourth check valves preventing flow in a direction and the other of the third and fourth check valves allows flow as the piston is moved toward the equilibrium position. The first check valve, the second check valve, the third check valve and the fourth check valves are one way check valves. These one way check valves are configured in a first direction to resist movements and configured in a second direction to isolate bases or other elements. In one embodiment, the input shaft, the piston and the chambers are part of a double acting hydraulic cylinder. The hydraulic actuator can be used as a damper in a vehicle suspension system, or used as a part of a tuned mass dampening system, such as in a building. In one embodiment, the actuator is used as a part of a tuned mass dampening system to reduce structural response in a building, such as a tuned mass dampening system to reduce structural response to a wind load in a building. The hydraulic actuator is a passive actuator. The hydraulic actuator in which moving the input shaft from the equilibrium position requires a high force when compared to the force needed to move the input shaft back to toward the equilibrium position. In some embodiments, the force needed to return the input shaft to a position near the equilibrium position is in the range of 0.6 of the force needed to move fluid to 0.2 of the force. In other embodiments, the range is 0.5 to substantially 0.1 of the force. In some embodiments, the range is 0.4 to substantially 0.09 of the force. In some embodiments the range is 0.3 to substantially 0.08 of the force. In some embodiments the range is 0.2 to substantially 0.06 of the force. In some embodiments, the range is 0.15 to substantially 0.05 of the force. In some embodiments the range is 0.5 to substantially zero. Suffice it to say that the return force is substantially less than the force needed to move the piston from the equilibrium position.

The foregoing description of the specific embodiments reveals the general nature of the invention sufficiently that others can, by applying current knowledge, readily modify and/or adapt for various applications without departing from the concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. An actuator comprising:
a housing;
a first chamber positioned within the housing near a first end of the housing;
a second chamber positioned within the housing near a second end of the housing;
a first piston having a first piston area, the first piston compressing fluid within the first chamber when moved in a first direction;
a second piston having a second piston area, the second piston compressing fluid within the second chamber when moved in a second direction;
a.pressure relief valve in fluid communication with the first chamber and the second chamber; and
a input shaft for moving the first piston in the first direction and the second piston in the second direction, the fluid flowing through the pressure relief valve to a fluid reservoir when one of the first piston is compressing fluid in the first chamber or the second piston is compressing fluid in the second chamber; and
a check valve at the output of the fluid reservoir that opens when the pressure on the fluid in one of the first chamber or the second chamber is released.

2. The actuator of claim 1 wherein the pressure relief valve determines an amount of force needed to move the piston.

3. The actuator of claim 1 wherein the pressure relief valve is adjustable.

4. The actuator of claim 1 wherein the input shaft has an equilibrium position between a first position where the first piston is exerting a force on the fluid in the first chamber and a second position where the second piston is exerting a force on the fluid in the second chamber.

5. The actuator of claim 4 wherein the force needed to move fluid from the first chamber is equal to the area of the first piston in contact with fluid in the first chamber multiplied by the reading of the pressure produced by the pressure relief valve.

6. The actuator of claim 4 wherein the force needed to move fluid from the second chamber is equal to the area of the second piston in contact with fluid in the second chamber multiplied by the reading of the pressure produced by the pressure relief valve.

7. The actuator of claim 4 wherein the force needed to return the input shaft to a position near the equilibrium position is in the range of 0.1 of the force needed to move fluid to substantially zero.

8. The actuator of claim 1 wherein the check valve opens to allow fluid in the fluid reservoir to flow back to one of the first chamber or the second chamber when the input shaft is moved from one of the first position or the second position toward the equilibrium position.

9. The actuator of claim 4 wherein the actuator further comprises:
a first return spring attached to the first piston to return the first piston to the equilibrium position, and
a second return spring attached to the second piston to return the first piston to the equilibrium position.

10. A hydraulic actuator comprising:
a housing having a center port;
a first chamber positioned within the housing near a first end of the housing;
a second chamber positioned within the housing near a second end of the housing;
a piston having a first piston area facing the first chamber and having a second piston area facing the second chamber, the piston in an equilibrium position when the center port is substantially covered by the piston;
a pressure relief valve in fluid communication with the first chamber and the second chamber;
a first fluid path in fluid communication with the first chamber, the second chamber and the pressure relief valve;
a second fluid path in fluid communication with the first chamber, the second chamber and the pressure relief valve; and
an input shaft for moving the piston in the first direction toward the first chamber, the fluid flowing through the pressure relief valve when the piston is compressing fluid in the first chamber, the input shaft for moving the piston in a second direction toward the second chamber and through the pressure relief valve when the piston is compressing fluid in the second chamber.

11. The hydraulic actuator of claim 10 further comprising:
a first check valve; and
a second check valve, one of the first and second check valves preventing flow in a direction and the other of the first and second check valves allowing flow as the piston is moved toward an equilibrium position.

12. The hydraulic actuator of claim 11 further comprising:
a third check valve; and
a fourth check valve, one of the third and fourth check valves preventing flow in a direction and the other of the third and fourth check valves allowing flow as the piston is moved toward an equilibrium position.

13. The hydraulic actuator of claim 12 wherein the first check valve, the second check valve, the third check valve and the fourth check valves are one way check valves.

14. The hydraulic actuator of claim 12 wherein the first check valve, the second check valve, the third check valve and the fourth check valves are one way check valves are configured in a first direction to resist movements and configured in a second direction to isolate bases.

15. The hydraulic actuator of claim 10 wherein the input shaft, the piston and the chambers are part of a double acting hydraulic cylinder.

16. The hydraulic actuator of claim 10 used as a damper in a vehicle suspension system.

17. The hydraulic actuator of claim 10 used as a part of a tuned mass dampening system in a building.

18. The hydraulic actuator of claim 10 used as a part of a tuned mass dampening system to reduce structural response in a building.

19. The hydraulic actuator of claim 10 used as a part of a tuned mass dampening system to reduce structural response to a wind load in a building.

20. The hydraulic actuator of claim 10 being a passive actuator.
